(19) United States
(12) Patent Application Publication
(10) Pub. No.: US 2025/0217147 A1
(43) Pub. Date: Jul. 3, 2025

(54) DEVICE, METHOD AND SYSTEM TO PROVIDE ACCESS TO A RESOURCE OF A PHYSICAL REGISTER FILE

(71) Applicant: Intel Corporation, Santa Clara, CA (US)

(72) Inventors: Regev Shemy, Haifa (IL); Gavri Berger, Haifa (IL); Shira Moscovich, Ramat-Gan (IL); Tomer Weiner, Mahane Miryam M (IL); Shimi Haleluya, Kfar Yona (IL); Gershon Rubinstein, Haifa (IL); Avi Atias, Santa Clara, CA (US)

(73) Assignee: Intel Corporation, Santa Clara, CA (US)

(21) Appl. No.: 18/397,648

(22) Filed: Dec. 27, 2023

(51) Int. Cl. G06F 9/30

(52) U.S. Cl. CPC G06F 9/3012

(57) ABSTRACT

Techniques and mechanisms for allocating resources of a physical register file (PRF) each to correspond to a respective logical register. In an embodiment, a PRF comprises multiple physical registers (or “entries”) which each comprise a respective two or more minimum allocable sub-portions. For a given one such entry, the minimum allocable sub-portions of the entry are available to be allocated either individually or in combination with each other. Allocation of a given one or more sub-portions of a PRF entry enables functionality of a corresponding logical register with said one or more sub-portions. At a given time, logical registers of different respective capacities are implemented with corresponding entry portions of the same PRF. In another embodiment, a bitmap facilitates a search to identify an availability of one or more PRF entry portions for allocation to correspond to a logical register.

### BACKGROUND

### 1. Technical Field

This disclosure generally relates to the field or processors and more particularly, but not exclusively, to the allocation of available space in a physical register file.

### 2. Background Art

An instruction set, or instruction set architecture (ISA), is the part of a computer architecture related to programming, and typically includes the native data types, instructions, register architecture, addressing modes, memory architecture, interrupt and exception handling, and external input and output (I/O). It should be noted that the term instruction generally refers herein to a macro-instruction—that is instructions that are provided to the processor (or instruction converter that translates (e.g., using static binary translation, dynamic binary translation including dynamic compilation), morphs, emulates, or otherwise converts an instruction to one or more other instructions to be processed by the processor) for execution—as opposed to micro-instructions or micro-ops—that result from a processor's decoder decoding macro-instructions).

The instruction set architecture is distinguished from the microarchitecture, which is the internal design of the processor implementing the ISA. Processors with different microarchitectures can share a common instruction set. For example, Intel Pentium 4 processors, Intel Core processors, and Advanced Micro Devices, Inc. of Sunnyvale Calif. processors implement nearly identical versions of the x86 instruction set (with some extensions having been added to newer versions), but have different internal designs. For example, the same register architecture of the ISA may be implemented in different ways in different micro-architectures using well known techniques, including dedicated physical registers, one or more dynamically allocated physical registers using a register renaming mechanism (e.g., the use of a Register Alias Table (RAT), a Reorder Buffer (ROB) and a retirement register file; the use of multiple maps and a pool of registers), etc. Unless otherwise specified, the phrases register architecture, register file, and register refer to that which is visible to the software/programmer and the manner in which instructions specify registers. Where specificity is desired, the adjective logical, architectural, or software visible will be used to indicate registers/files in the register architecture, while different adjectives will be used to designate registers in a given microarchitecture (e.g., physical register, reorder buffer, retirement register, register pool).

A physical register file (PRF) is one of the basic structures of a given processing unit. This structure supports an abstraction functionality whereby several instances of the same logical register are able to to exist at the same time within an out-of-order machine, wherein each such instance's data is stored within a different physical register within a physical register file (PRF). Over time, the sizes of physical registers has tended to increase with successive generations of processor architectures. However, a given logical register usually has one of multiple different sizes, as defined by the architecture. As a result, there is expected to be an increasing premium placed on improvements to efficiently map various available spaces in a physical register file each to a respective logical register.

### BRIEF DESCRIPTION OF THE DRAWINGS

The various embodiments of the present invention are illustrated by way of example, and not by way of limitation, in the figures of the accompanying drawings and in which:

FIG. 1 shows a block diagram illustrating features of a system to variously access different entries of a physical register file (PRF) according to an embodiment.

FIG. 2 shows a flow diagram illustrating features of a method to provide access to a PRF according to an embodiment.

FIG. 3 shows a block diagram illustrating features of a device to allocate variously sized portions of a PRF each to a respective logical register according to an embodiment.

FIG. 4 shows a block diagram illustrating features of a device to identify a physical register with a register alias table (RAT) according to an embodiment.

FIG. 5 shows a block diagram illustrating features of a device to access variously sized portions of a PRF according to an embodiment.

FIG. 6 shows a block diagram illustrating features of a device to variously map logical registers each to a different respective physical register portion according to an embodiment.

FIG. 7 shows a format diagram illustrating features of a bitmap to identify physical register portions as being variously allocated each to a respective logical register according to an embodiment.

FIG. 8 illustrates an exemplary system.

FIG. 9 illustrates a block diagram of an example processor that may have more than one core and an integrated memory controller.

FIG. 10A is a block diagram illustrating both an exemplary in-order pipeline and an exemplary register renaming, out-of-order issue/execution pipeline according to examples.

FIG. 10B is a block diagram illustrating both an exemplary example of an in-order architecture core and an exemplary register renaming, out-of-order issue/execution architecture core to be included in a processor according to examples.

FIG. 11 illustrates examples of execution unit(s) circuitry.

FIG. 12 is a block diagram of a register architecture according to some examples.

### DETAILED DESCRIPTION

Embodiments discussed herein variously provide techniques and mechanisms for facilitating the access of a physical register file (PRF). In some embodiments, a PRF comprises multiple physical registers (also referred to herein as “PRF entries” or, for brevity, simply “entries”), which are available at various times each to be allocated to correspond to a respective one or more logical registers. Unless otherwise indicated, “allocate,” “allocated,” “allocation,” and related terms variously refer herein to the allocation of at least a portion of a PRF entry to correspond to a logical register—e.g., wherein the allocation results in said portion implementing functionality of that corresponding logical register in one or more respects.

Some embodiments variously facilitate a granular allocation of any of various selectable portions of a PRF entry to correspond to a logical register. Such allocation of a given portion of a PRF entry (also referred to herein as “PRF entry portion” or, for brevity, simply “entry portion”) is to enable the corresponding logical register to be used as a basis for accessing the allocated PRF entry portion. For example, while a given logical register corresponds to a particular entry portion, that entry portion is to store information which is to be accessed based on the execution of an instruction (if any) which includes a reference to, or otherwise indicates, that logical register.

Unless otherwise indicated, the terms “capacity” and “size”—as used herein in the context of a PRF entry, a logical register, or other such resource—variously refer to a maximum possible amount of information which could be accessed at (e.g., read from and/or written to) the resource in question. In some embodiments, a PRF entry portion is selected to be allocated to correspond to a logical register which is of a particular register type, wherein such allocation is based on both a capacity of the PRF entry, and a capacity which is associated with the register type.

The term “allocated entry portion” refers herein to an entry portion which currently corresponds to, a particular logical register. The term “entry sub-portion” refers herein to a portion of a PRF entry, wherein said portion is less than all of said PRF entry. In an embodiment, the selection of an entry portion for allocation comprises the selection of one or more entry sub-portions, each of which provides a minimum incremental amount of allocable capacity. By way of illustration and not limitation, a given one of such one or more entry sub-portions (also referred to herein as a “minimum entry sub-portion” or, for brevity, simply “minimum sub-portion”) has a capacity which is equal to a power of one half—i.e., (½)^{x}, where x is a positive integer—of the total capacity of a PRF entry.

In contrast to an allocated entry portion, the term “available portion” refers herein to an entry portion which does not currently correspond to any logical register. The term “partially allocated entry” refers herein to a PRF entry, one or more minimum sub-portions of which are currently allocated, and one or more other minimum sub-portions of which are currently available. The term “fully allocated entry” refers herein to a PRF entry, each minimum sub-portion of which is currently allocated. The term “uniquely allocated entry” refers herein to a fully allocated PRF entry, each minimum sub-portion of which is currently allocated to the same logical register. As described herein, some embodiments variously enable a concurrent correspondence of logical registers each to a respective one of PRF entry portions which have different respective capacities—e.g., wherein a first PRF entry is a uniquely allocated entry while a second PRF entry is partially allocated to one logical register, as well as partially allocated to a different logical register.

The technologies described herein may be implemented in one or more electronic devices. Non-limiting examples of electronic devices that may utilize the technologies described herein include any kind of mobile device and/or stationary device, such as cameras, cell phones, computer terminals, desktop computers, electronic readers, facsimile machines, kiosks, laptop computers, netbook computers, notebook computers, internet devices, payment terminals, personal digital assistants, media players and/or recorders, servers (e.g., blade server, rack mount server, combinations thereof, etc.), set-top boxes, smart phones, tablet personal computers, ultra-mobile personal computers, wired telephones, combinations thereof, and the like. More generally, the technologies described herein may be employed in any of a variety of electronic devices including circuitry to variously allocate resources of a physical register file.

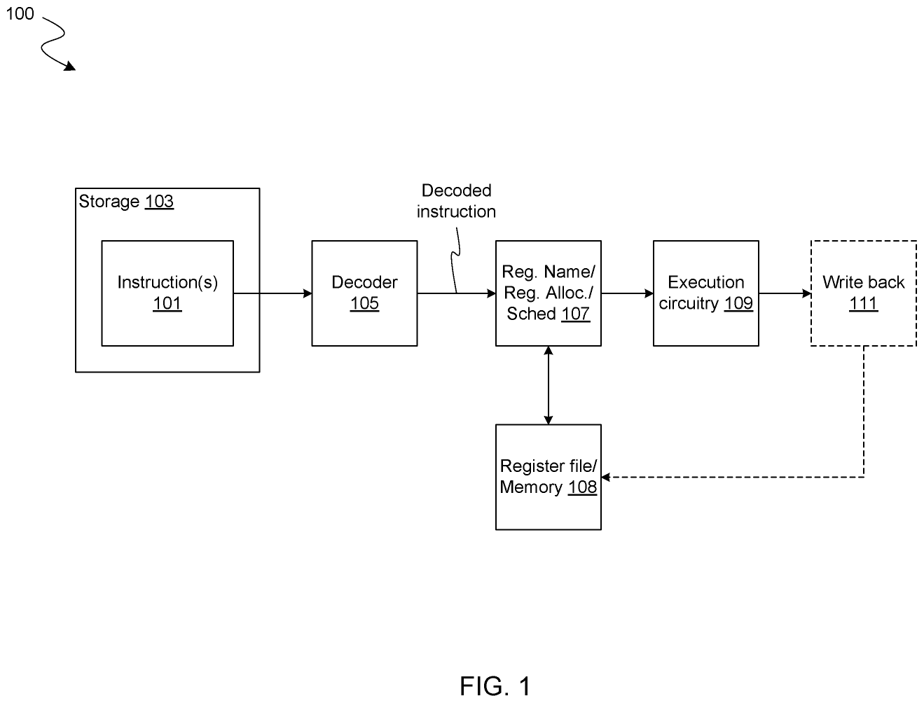

FIG. 1 shows a system 100 which variously provides access to different entries of a physical register file (PRF) according to an embodiment. The system 100 illustrates features of one example embodiment which variously identify portions of PRF entries each as corresponding to a respective logical register. In some embodiments, a first PRF entry portion and a second PRF entry portion are variously allocated to correspond to different respective logical registers, wherein a capacity of the first PRF entry portion is different than a capacity of the second PRF entry portion.

As shown in FIG. 1, system 100 comprises (or alternatively, is to be coupled to) a storage 103 to store a one or more instructions 101 which are to be executed. For example, a given one of instruction(s) 101 is received by decoder circuitry 105 of system 100. In an embodiment, decoder circuitry 105 receives this instruction from fetch circuitry (not shown). The instruction may be in any of various suitable formats, which are not limiting on some embodiments. In an example, the instruction includes fields for an opcode, as well as one or more source identifiers and/or one or more destination identifiers. In some examples, the opcode details a type of operation which is to be performed. In some examples, a given source (or destination) is a register, and in other examples one or more are memory locations. In some examples, one or more of the sources may be an immediate operand. In various embodiments, an identifier or a logical register is provided in a source identifier field or a destination identifier field, for example. Additionally or alternatively, an opcode field is (for example) implicitly associated with a logical register which is to be accessed as part of, or as a result of, the execution of the instruction.

The decoder circuitry 105 decodes the instruction into one or more operations. In some examples, this decoding includes generating a plurality of micro-operations to be performed by execution circuitry (such as execution circuitry 109) of system 100. The decoder circuitry 105 also decodes instruction prefixes, for example.

In some examples, register renaming, register allocation, and/or scheduling circuitry 107 provides functionality for one or more of: 1) renaming logical operand values to physical operand values (e.g., a register alias table in some examples), 2) allocating status bits and flags to the decoded instruction, and 3) scheduling the decoded instruction for execution by execution circuitry out of an instruction pool (e.g., using a reservation station in some examples).

Registers (of a physical register file, for example) and/or memory 108 store data and/or other information as operands of the instruction to be operated on by execution circuitry 109. Some exemplary register types include, but are not limited to, packed data registers, general purpose registers (GPRs), and floating-point registers.

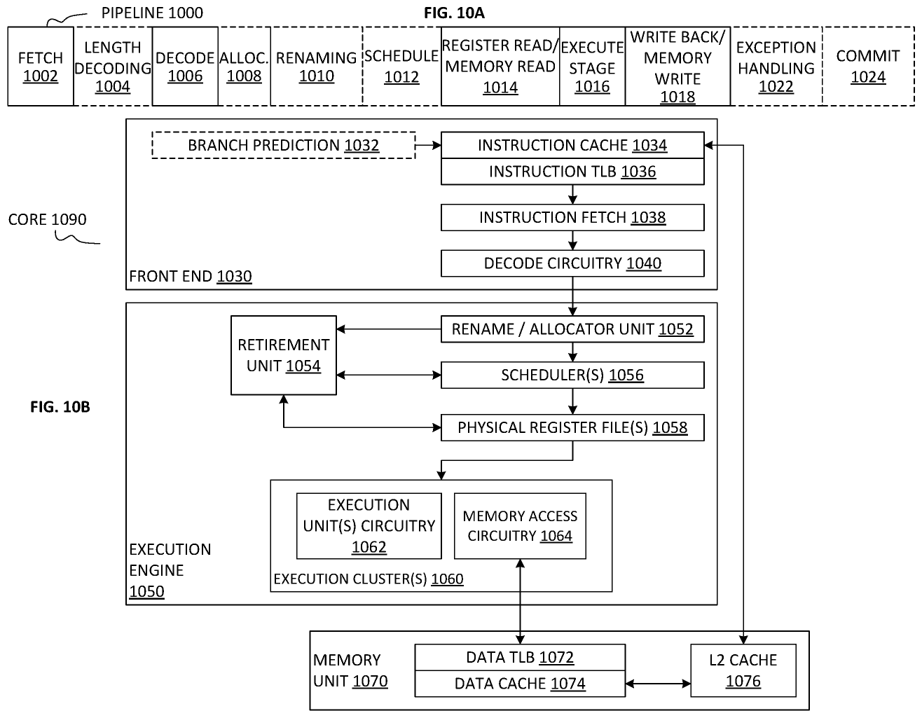

Execution circuitry 109 executes the decoded instruction. Exemplary detailed execution circuitry includes execution cluster(s) 1060 shown in FIG. 10B, etc. The execution of the decoded instruction causes the execution circuitry 109 to perform one or more operations which, for example, include, are based on, and/or result in one or more entries of a physical register file being accessed (e.g., read from and/or written to).

In some examples, retirement/write back circuitry 111 architecturally commits the destination register into the registers or memory 108 and retires the instruction.

An example of a format for an illustrative instruction is OPCODE DST, SRC1, SRC2. In some examples, OPCODE is the opcode mnemonic of the instruction. DST is a field for a destination operand, which specifies or otherwise indicates a physical register (e.g., a packed data register) or memory. SRC1 and SRC2 are fields for source operands, which specify or otherwise indicate a respective physical register (e.g., a packed data register), and/or memory.

Unless otherwise indicated, the term “register” refers herein to any of various processor storage locations that, for example, are suitable for use as one or more parts of an instruction (e.g., to identify an operand thereof). In an embodiment, one or more registers are usable from the outside of the processor (from a programmer's perspective). However, the registers of some embodiments should not be limited in meaning to a particular type of circuit. Rather, a register of an embodiment is capable of storing and providing data, and performing the functions described herein. The registers described herein can be implemented by circuitry within a processor using any number of different techniques, such as dedicated physical registers, dynamically allocated physical registers using register renaming, combinations of dedicated and dynamically allocated physical registers, etc.

A physical register file (PRF) of one embodiment comprises multiple physical registers (also referred to herein as “PRF entries” or, for brevity, simply “entries”). Certain features are described herein with reference to the use of PRF entries to hold data. However, it is to be appreciated that such description can be extended, in various embodiments, to apply to PRF entries which additionally or alternatively hold any of various other types of information (such as addresses, opcodes, and/or the like).

In various illustrative embodiments, a given PRF entry—or at least a portion thereof—is suitable to hold 2ⁿ bits of information (where n is a positive number). By way of illustration and not limitation, at least a portion of a PRF entry has the same capacity as that of a 64 bits wide MMX™ register (also referred to as ‘mm’ registers in some instances) such as that in microprocessors which are enabled with MMX technology from Intel Corporation of Santa Clara, Calif. These MMX registers, available in both integer and floating point forms, can operate with packed data elements that accompany SIMD and SSE instructions, for example. Alternatively or in addition, a given PRF entry portion has the same capacity as that of a 128 bits wide xmm register such as that relating to SSE2, SSE3, SSE4 (referred to generically as “SSEx”) technology. Alternatively or in addition, a given PRF entry portion has the same capacity as that of a 256 bits wide ymm register or, for example, a 512 bits wide zmm register relating to AVX, AVX2, AVX3 technology (or beyond).

Some embodiments variously enable the configuration of a logical register which functions as, or otherwise facilitates implementation of, an operand and/or other resource that is used in the execution of the one or more instructions 101. For example, such configuration comprises allocating a PRF entry portion—e.g., a portion of a physical register of the registers and/or memory 108—to correspond to said logical register. One such embodiment facilitates a granular allocation of any of various selectable portions of a PRF entry to correspond to the logical register. This granular allocation promotes efficient use of PRF resources by enabling PRF entry portions of various capacities to concurrently correspond each to a different respective logical register. In various embodiments, the register renaming, register allocation, and/or scheduling circuitry 107, the registers or memory 108, and/or other suitable logic of system 100 comprises one or more circuits each to perform a respective one or more operations which are described herein (e.g., including some or all operations of method 200).

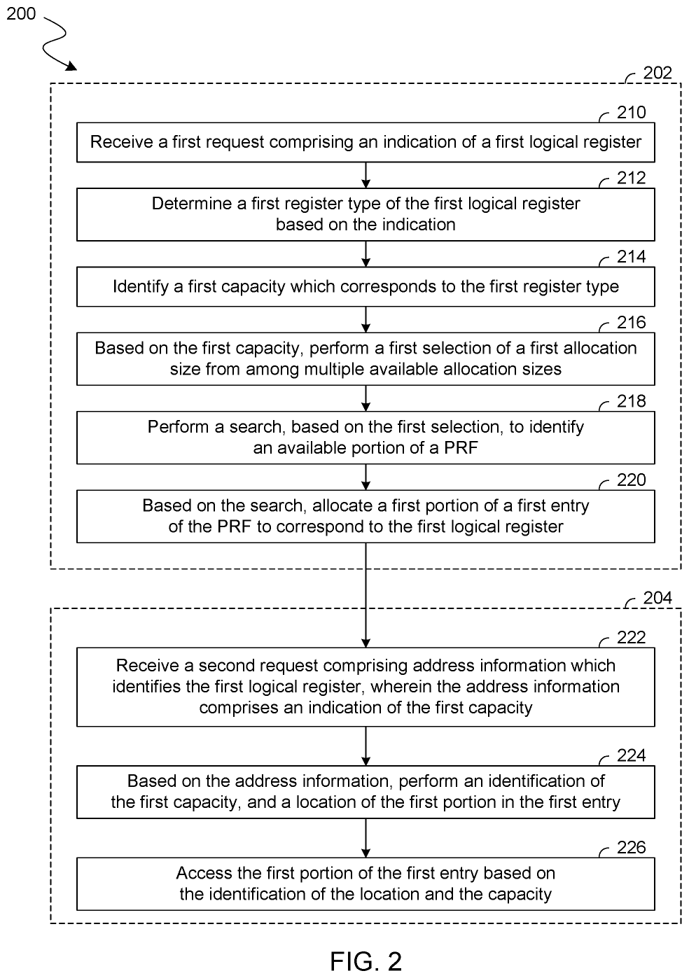

FIG. 2 shows a method 200 for providing access to a PRF according to an embodiment. The method 200 illustrates one example of an embodiment wherein a PRF entry portion is allocated to facilitate functionality of a logical register. Operations such as those of method 200 are performed with any of various combinations of suitable hardware (e.g., circuitry), firmware and/or executing software which, for example, provide some or all of the functionality of system 100.

In the example embodiment, method 200 comprises operations 202 which initially determine a correspondence of a logical register to a particular entry portion of a PRF. As shown in FIG. 2, operations 202 comprise (at 210) receiving a first request comprising an indication of a first logical register. In some embodiments, the first request is a request (e.g., implicit or explicit) for an allocation of a PRF entry (or at least a portion thereof) to correspond to the logical register. For example, the first request includes, or is otherwise based on, a request to execute an instruction comprising an operand which, for example, is indicated with an identifier of a logical register for which a PRF entry portion has yet to be allocated.

Although some embodiments are not limited in this regard, the indication of the first logical register is (for example) a label of a register which is of a particular register type. By way of illustration and not limitation, the indication includes a particular register label (e.g., one of xmm0, xmm3 or the like) associated with a xmm register type. Alternatively, the indication includes a particular register label (e.g., one of ymm1, ymm4 or the like) associated with a ymm register type. Alternatively, the indication includes a particular register label (e.g., one of zmm2, zmm5 or the like) associated with a zmm register type. In other embodiments, the indication comprises any of various other register labels which, for example, are associated with any of various other suitable register types.

Based on the indication of the first request received at 210, operations 202 (at 212) determine a first register type of the first logical register. For example, the determining at 212 comprises identifying—e.g., based on a register label or other suitable identifier which is provided with the first request—one of a xmm register type, a ymm register type, a zmm register type, or the like.

The operations 202 further comprise (at 214) identifying a first capacity which corresponds to the first register type. For example, the identifying at 214 includes accessing a lookup table or other suitable resource comprising reference information which identifies multiple different register types as corresponding each to a respective capacity. In one example embodiment, such reference information specifies or otherwise indicates a correspondence of a xmm type to a 128-bit capacity, a correspondence of a ymm type to a 256-bit capacity, a correspondence of a zmm type to a 512-bit capacity, and/or the like. In one such embodiment, the identified first capacity is one of a 128-bit capacity, a 256-bit capacity, or a 512-bit capacity (for example).

Based on the first capacity which is identified at 214, operations 202 (at 216) perform a first selection of a first allocation size from among multiple available allocation sizes. In some embodiments, the first allocation size is selected from among multiple available allocation sizes that comprise a relatively large allocation size which (for example) is equal to a capacity of an entire PRF entry, and a relatively small allocation size. In one such embodiment, the relatively small allocation size is equal to ½ of the relatively large allocation size. For example, the multiple available allocation sizes comprise some or all of a 128-bit size, a 256-bit size, and a 512-bit size. In some embodiments, performing the first selection at 216 comprises determining a total number of one or more minimum entry sub-portions which can provide a total capacity sufficient to accommodate the first capacity.

Based on the first selection performed at 216, operations 202 (at 218) perform a search to identify an available portion of a PRF. For example, the search performed at 218 includes searching a register alias table (RAT), or other suitable resource, which maps logical registers each to a different respective PRF entry portion. In some embodiments, such a RAT supports mapping at a level of granularity which is smaller than one entire PRF entry. In one such embodiment, the RAT supports mapping at multiple different levels of granularity, including up to one entire PRF entry. In one example embodiment, a RAT is searched at 218 using address information (or any of various other suitable identifiers) for a given PRF entry portion. Such a search is successful, for example, where it determines that the PRF entry portion in question is not currently mapped to any logical register.

Alternatively or in addition, the search performed at 218 comprises searching a bitmap comprising bits which each correspond to a different respective minimum entry sub-portion, wherein each such bit identifies whether the corresponding minimum entry sub-portion is currently allocated to a respective logical register. In one such embodiment, the bitmap search is performed at 218 to identify a PRF entry, and one or more currently available minimum sub-portions of said PRF entry—e.g., wherein a total capacity of the one or more currently available minimum sub-portions is able to accommodate (e.g., is equal to) the first capacity.

Based on the search at 218, operations 202 (at 220) allocate a first portion of a first entry of the PRF to correspond to the first logical register. In an embodiment, the allocating at 219 includes, or is performed in combination with, an updating of reference information (e.g., provided with the above-described RAT and/or the above-described bitmap) to identify, for each of the one or more minimum entry sub-portions of the first portion, that the minimum entry sub-portion in question is currently allocated.

In some embodiments, method 200 additionally or alternatively comprises operations 204 which access a particular entry portion such as the one which, based on operations 202, corresponds to a logical register. In the example embodiment shown, operations 204 comprise (at 222) receiving a second request comprising address information which identifies the first logical register, wherein the address information comprises an indication of the first capacity. For example, the second request includes, or is otherwise based on, another request to execute an instruction comprising an operand which, for example, is indicated with an identifier of the logical register. By way of illustration and not limitation, the second request is a request to read information at (and/or to write information to) a location which is indicated by the logical register.

Based on the address information received at 222, operations 204 (at 224) perform an identification of the first capacity, and a location of the first portion in the first entry. For example, in an embodiment, the address information includes a logical (or “virtual”) address which, at least, identifies the logical register and, in some embodiments, further specifies or otherwise indicates a particular (sub)portion of a PRF entry. In an illustrative scenario according to one embodiment, the PRF comprises 2^{m} entries (wherein m is a first integer), wherein the first capacity is equal to that of an entire PRF entry. In one such embodiment, the first capacity is indicated by the address information consisting of only m bits. For example, capacity identifier logic of one embodiment is configured to determine, based on such address information, that the first logical register is allocated to correspond to an entire PRF entry—e.g., since no additional address information is provided to identify a more particular sub-portion of said PRF entry.

In an alternative scenario wherein the PRF comprises 2^{m} entries, the first capacity is indicated by the address information comprising n bits (wherein n is an integer greater than m bits. For example, capacity identifier logic of another (or the same) embodiment is configured to determine, based on such address information, that the first logical register is allocated to correspond to only a sub-portion of a PRF entry—e.g., wherein m address bits identify the PRF entry, and wherein the additional address bit or bits specify or otherwise indicate one or more characteristics of a particular sub-portion of the PRF entry. In one such embodiment, n is equal to m plus one (m+1), wherein the additional address bit is to specify a particular one of two possible sub-portions of the first entry—e.g., one of a lower half sub-portion or an upper half sub-portion. In another such embodiment, n is greater than m plus one (m+1), wherein the additional address bits indicate whether the first logical register corresponds to only a sub-portion (rather than all) of a PRF entry, and further indicate a particular capacity and/or location of the corresponding (sub)portion in the PRF entry.

Accordingly, some embodiments enable the same address space to be used for the selective identification of either a relatively small logical register which (at a given time) corresponds to only a sub-portion of a given PRF entry, or a relatively large logical register which (at another time) corresponds to a larger portion—e.g., to all—of that given PRF entry. Such use of one address space—e.g., wherein m out of n bits are shared for use in addressing (at various times) differently sized portions of the same PRF entry—eliminates or otherwise mitigates the need for additional management circuitry and/or operations. For example, this more efficient address space use avoids the need for some operations (and supporting circuitry) which would otherwise be used to help control use of, and/or an interface with, the PRF registers.

Based on the identification of the location and the capacity which are identified at 224, operations 204 (at 226) access the first portion of the first entry. For example, the accessing at 226 comprises reading information from the first portion, or writing information to the first portion.

In various embodiments, method 200 comprises one or more additional operations (not shown) by which logical registers concurrently correspond to different respective PRF entry portions of various capacities. For example, such additional operations comprise receiving a third request which comprises an indication of a second logical register. A second register type of the second logical register is determined based on such an indication. In one such embodiment, the additional operations further identify a second capacity which corresponds to the second register type, wherein the second capacity is different than the first capacity. Based on the second capacity, a second allocation size is selected from among the multiple available allocation sizes. A search is then performed, based on the second selection, to identify an available portion of the PRF. Based on the search, a second portion of a second PRF entry is allocated to correspond to the second logical register. In one such embodiment, the first portion of the first entry corresponds to the first logical register while the second portion of the second entry corresponds to the second logical register (and, for example, while a third portion of the second entry corresponds to a third logical register).

In various embodiments, method 200 comprises one or more additional operations (not shown) to facilitate a deallocation, and/or reallocation, of a given logical register from corresponding to a PRF entry portion. In one such embodiment, a deallocation includes, or is performed in combination with, an updating of reference information, such as that of a bitmap which identifies, for each minimum entry sub-portion of a PRF, whether the minimum entry sub-portion is currently allocated to a respective logical register.

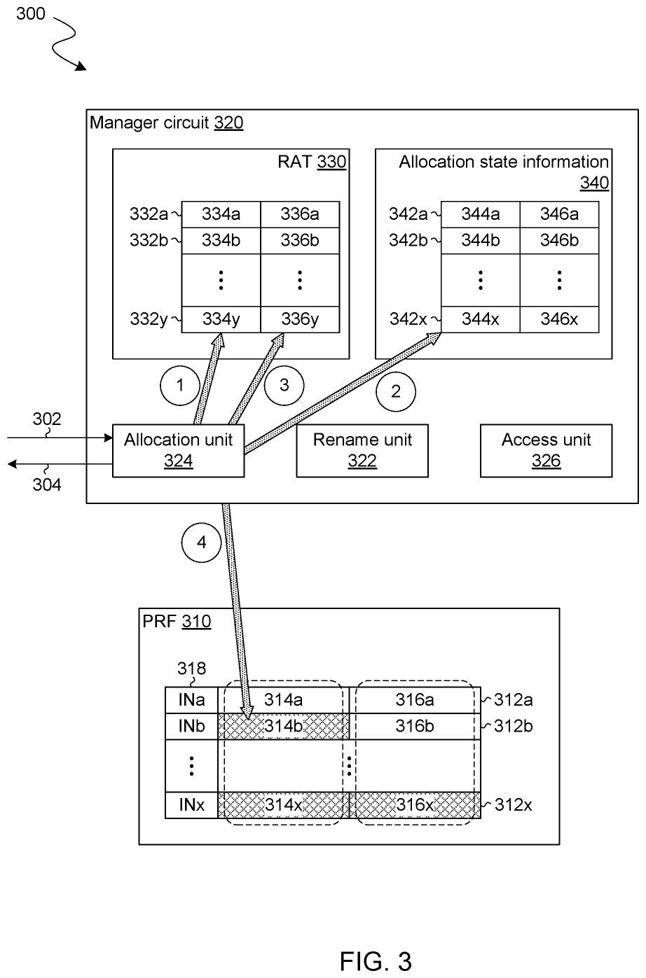

FIG. 3 shows a device 300 which allocates variously sized portions of a PRF each to a respective logical register according to an embodiment. The device 300 illustrates features of one example embodiment which allocates at least a portion of a PRF entry to implement functionality of a corresponding logical register. In some embodiments, device 300 provides functionality such as that of system 100—e.g., wherein operations of method 200 are performed with some or all of device 300.

As shown in FIG. 3, device 300 comprises a manager circuit 320 and (in some embodiments) a physical register file (PRF) 310, wherein allocation of PRF resources is to be managed with manager circuit 320. For example, in various embodiments, an allocation unit 324, an access unit 326, and/or other suitable logic of of manager circuit 320 comprises one or more circuits each to perform a respective one or more operations which are described herein (e.g., including some or all operations of method 200).

In an embodiment, PRF 310 comprises multiple entries (such as the illustrative entries 312a, 312b, . . . , 312x shown), respective portions of which are available to be variously allocated each to correspond to a respective logical register. Indices 318 (such as the illustrative index values INa, INb, . . . , INx shown) of PRF 310 comprise respective labels, physical addresses and/or other information which is suitable to facilitate the identification and accessing of a particular one of the PRF entries 312.

In the example embodiment shown, entry 312a comprises at least two minimum allocable sub-portions 314a, 316a—e.g., wherein the first minimum sub-portion 314a and the second minimum sub-portion 316a each have a respective capacity which is equal to one half of a total capacity of entry 312a. The minimum sub-portions 314a, 316a are available to be allocated, in combination with each other, to correspond to a single logical register which is of a relatively large register type (e.g., a zmm type). In addition, minimum sub-portions 314a, 316a are available to instead be individually allocated to different respective logical registers which are each of a relatively small register type (e.g., a ymm type, relative to a zmm type). In one such embodiment, entry 312b similarly comprises minimum allocable sub-portions 314b, 316b which are available to be allocated either individually or in combination with each other. Furthermore, entry 312x similarly comprises minimum allocable sub-portions 314x, 316x which are available to be allocated either individually or in combination with each other.

Manager circuit 320 includes, is coupled to access, or otherwise operates based on, state information which specifies or otherwise indicates a current correspondence of logical registers each with a respective entry portion of PRF 310. By way of illustration and not limitation, such state information comprises mapping information which is provided with a register alias table (RAT) 330. RAT 330 is implemented in any of various suitable manners to provide mappings between logical registers and PRF entry portions.

In the example embodiment shown, RAT 330 include entries (such as the illustrative entries 332a, 332b, . . . , 332y shown) which each correspond to a different respective logical register. For example, the number of such entries of RAT 330 is equal to the maximum number of logical registers allowed in device 300. Such a maximum number may be defined by, for example, an architecture used for device 300 such as an instruction set architecture (ISA). Thus, the entries 332 of RAT 330 may be indexed by identification of possible logical registers.

In an embodiment, each entry 332 of RAT 330, if populated with a mapping between a logical register and a PRF entry portion, include an identifier of a PRF entry portion. The PRF entry portion is thus mapped on the logical register associated with the RAT entry's index. In one such embodiment, a change in whether or how a given PRF entry portion is assigned to a given logical register (represented by an entry at the index for the given logical register) is performed by removing or changing the identifier of the PRF entry portion in the RAT entry.

In an illustrative scenario according to one embodiment, entry 332a comprises a first field 334a (e.g., an index field) to store an identifier of a first logical register, and further comprises a second field 336a to identify a particular PRF entry portion as corresponding to the first logical register. Furthermore, entry 332b similarly comprises fields 334b, 336b to (respectively) an identifier of a second logical register and an identifier of a corresponding second PRF entry portion. Further still, entry 332y similarly comprises fields 334y, 336y to (respectively) an identifier of a second logical register and an identifier of a corresponding second PRF entry portion.

In some embodiments, manager circuit 320 also uses allocation state information 340 which specifies, for each of the minimum allocable entry sub-portions of PRF 310, whether or not that minimum entry sub-portion is currently allocated. In one such embodiment, state information 340 is provided with a table, bitmap, or other suitable data structure which, for example, is comprises entries (or sets of bits)—such as the illustrative entries 342a, 342b, . . . , 342x shown—that each correspond to a different respective one of entries 312a, 312b, . . . , 312x. For a given one of entries 342a, 342b, . . . , 342x, the entry 342 comprises two or more fields which each correspond to a different respective minimum allocable sub-portion of the corresponding PRF entry. By way of illustration and not limitation, entry 342a comprises fields 344a, 346a which correspond (respectively) to a first minimum sub-portion 314a and a second minimum sub-portion 316a of entry 312a. Furthermore, entry 342b similarly comprises fields 344b, 346b which correspond (respectively) to a first minimum sub-portion 314b and a second minimum sub-portion 316b of entry 312b. Further still, entry 342x similarly comprises fields 344x, 346x which correspond (respectively) to a first minimum sub-portion 314x and a second minimum sub-portion 316x of entry 312x.

In an illustrative scenario according to one embodiment, an allocation unit 324 of manager circuit 320 receives a signal 302 which includes an identifier of a logical register. Signal 302 implicitly or explicitly requests that the logical register be allocated, if necessary, to correspond to an entry portion of PRF 310. By way of illustration and not limitation, the signal 302 comprises the first request which is received at 210 in method 200.

Based on signal 302, allocation unit 324 performs a search of RAT 330 (the search indicated by the label “1”) to determine whether the logical register which is identified by signal 302 is currently allocated to correspond to any entry portion of PRF 310. Where the search of RAT 330 results in a miss, allocation unit 324 performs another search of the allocation state information 340 (the other search indicated by the label “2”) to identify an entry portion of PRF 310—e.g., the entry portion comprising one or more minimum allocable sub-portions of a given PRF entry 312—which is both available to be (re)allocated, and has a capacity that can accommodate the capacity associated with a register type of the identified logical register.

In an example scenario, the logical register which is identified by signal 302 is of a register type which corresponds to a capacity that is equal to that of one minimum allocable sub-portion of PRF 310. In one such scenario, the search of state information 340 identifies the minimum allocable sub-portion 314b (for example) of entry 312b as a candidate to be allocated to correspond to the logical register. Based on such identification, an updating of RAT 330 is performed (as indicated by the label “3”) so that a RAT entry identifies a correspondence of the logical register to first minimum sub-portion 314b. Furthermore, state information 340 is updated to indicate that first minimum sub-portion 314b is currently allocated. In some embodiments, allocation unit 324—or other suitable logic of manager circuit 320—also stores to first minimum sub-portion 314b (the storing indicated by the label “4”) data and/or other information which is to be accessible to software by use of a logical address or other identifier of the logical register. Although some embodiments are not limited in this regard, allocation unit 324—or other suitable logic of manager circuit 320—provides a signal 304 to specify or otherwise indicate to one or more other resources (not shown) that functionality of the identified logical register is now supported by first minimum sub-portion 314b.

In another example scenario, the logical register which is identified by signal 302 is of a register type which corresponds to a capacity that is equal to that of two minimum allocable sub-portions of PRF 310. In one such scenario, the search of state information 340 identifies the minimum allocable sub-portions 314x, 316x (for example) of entry 312x as candidates to be allocated, in combination with each other, to correspond to the logical register. Based on such identification, an updating of RAT 330 is performed so that a RAT entry identifies a correspondence of the logical register to minimum sub-portion 314x, 316x. Furthermore, state information 340 is updated to indicate that minimum sub-portions 314x, 316x are currently allocated. In some embodiments, allocation unit 324—or other suitable logic of manager circuit 320—also stores to minimum sub-portions 314x, 316x data and/or other information which is to be accessible to software by use of a logical address or other identifier of the logical register.

In some embodiments, manager circuit 320 further comprises a rename unit 322 which provides functionality to change an allocation of a given logical register, from corresponding to one PRF entry portion to corresponding to another PRF entry portion. Additionally or alternatively, manager circuit 320 further comprises an access unit 326 which provides functionality to access an allocated PRF entry portion based on an identifier of a logical register which currently corresponds thereto.

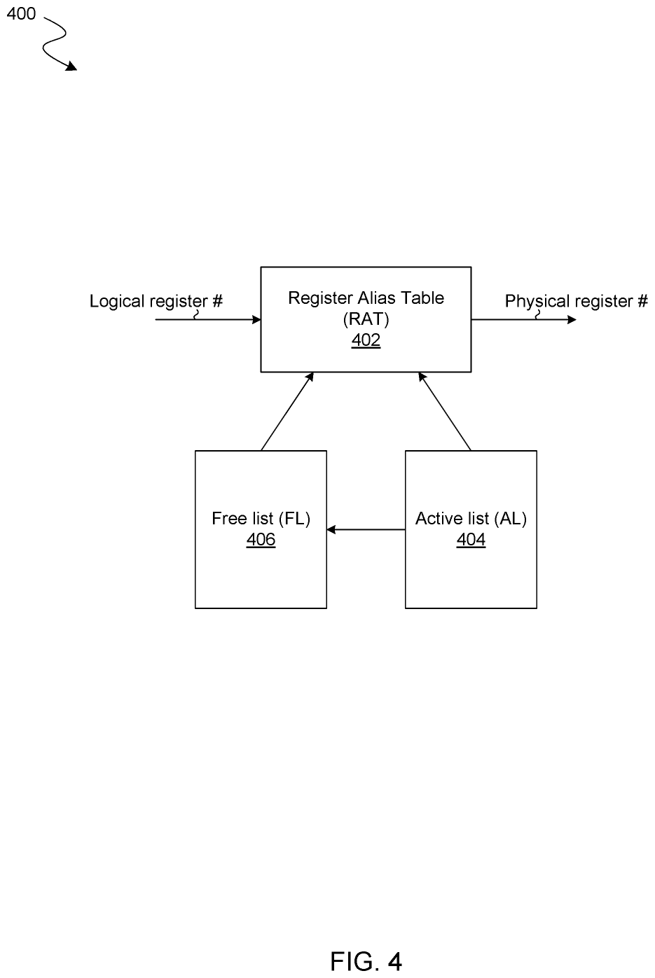

FIG. 4 shows a device 400 which identifies a physical register with a register alias table (RAT) according to an embodiment. Device 400 illustrates features of one example embodiment which corresponds logical registers each to a different respective one of multiple PRF entry portions which have various respective capacities. In some embodiments, device 400 provides functionality such as that of system 100 or device 300—e.g., wherein operations of method 200 are performed with some or all of device 400.

Most instructions operate on several source operands and generate results. Typically, they name, either explicitly or through an indirection, the source and destination locations where values are read from or written to. For example, such a name is often a label or virtual address of a logical (architectural) register.

Usually, the number of physical registers available for a processor exceeds the number of logical registers, so that register renaming may be utilized to increase performance. Renaming a logical register involves mapping a logical register to a physical register. These mappings are usually stored in a register alias table (RAT). A RAT maintains the current mapping for some or all logical registers. In an embodiment, a RAT is indexed by logical registers, and provides mappings to corresponding physical registers (e.g., entries of a PRF).

As shown in FIG. 4, device 400 comprises a PRF entry portion renaming and dependency tracking scheme involving three structures: a RAT 402, an active list (AL) 404, and a free list (FL) 406. For a given logical register which is not currently allocated, an unused PRF entry portion—e.g., comprising one or more minimum allocable entry sub-portions—is identified in FL 406 and allocated to correspond to (that is, to be mapped to) said logical register. In an embodiment, the RAT 402 is updated with this new mapping. PRF entry portions are free to be used again (i.e., reclaimed) once they are deallocated—e.g., after they cannot be referenced by instructions in a current instruction window.

Based upon the data structures depicted in FIG. 4, one method for PRF entry portion reclaiming is to reclaim an entry portion when an instruction, which resulted in that entry portion's eviction from RAT 402, retires. Thus, the instruction that created the new allocation to the PRF entry portion is retired for reclaiming to occur. As a result, whenever a new allocation updates RAT 402, the evicted old allocation is pushed into active list 404. In some embodiments, an active list 404 entry is associated with each instruction in a current instruction window. When an instruction retires, the PRF entry portion evicted from RAT 402 and recorded in active list 404, if any, is reclaimed and pushed into free list 406. The cycle is depicted in FIG. 4.

In various embodiments, the retirement of a PRF entry portion includes, or is otherwise based on, a retirement of a logical register to which that PRF entry portion is allocated. In some embodiments, wherein a processor supports out-of-order execution functionality, retirement of a PRF entry portion is delayed at least until the retirement of one or more other instructions which depend upon the logical register. In an embodiment wherein (for example) RAT allocation and re-order buffer retirement are performed in order, retirement of a PRF entry portion results in the retirement of all previous dependencies upon the logical register which had corresponded to the PRF entry portion.

In an illustrative scenario according to one embodiment, during register renaming, free list 406 allocates an unused PRF entry portion when an instruction specifies a logical, or architectural, register as a destination. The instruction source PRF entry portions are identified, using RAT 402, based on the instruction source logical registers. Afterwards, RAT 402 maps a destination entry portion to the newly allocated physical register from free list 406. When a destination logical register is renamed, subsequent instructions cannot read the entry portion that previously was mapped to that logical register. As discussed above, an appropriate condition for entry portion reclaiming is to reclaim a PRF entry portion when the instruction that generated the new mapping in RAT 402 retires. Further, the old mapping is pushed into active list 404 from RAT 402. When the corresponding instruction retires, the old mapping is reclaimed and pushed into free list 406.

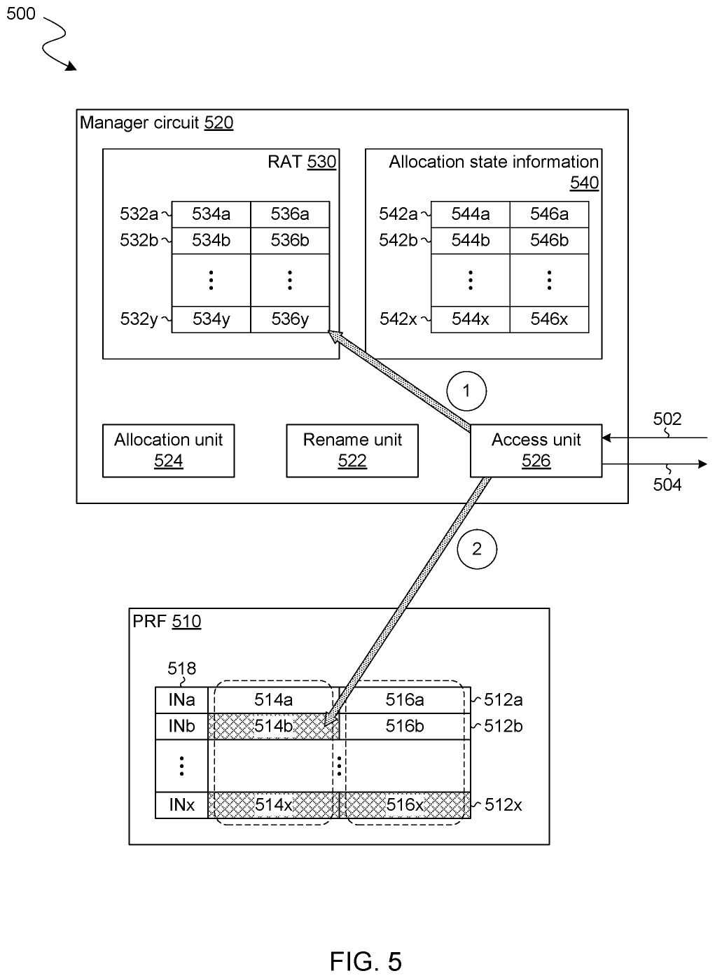

FIG. 5 shows a device 500 which accesses variously sized portions of a PRF according to an embodiment. Device 500 illustrates features of one example embodiment which accesses any of various PRF entry portions (some or all of which have different respective capacities) based on an identifier of a logical register. In some embodiments, device 500 provides functionality of system 100, device 300, or device 400—e.g., wherein operations of method 200 are performed with some or all of device 500.

As shown in FIG. 5, device 500 comprises a PRF 510 and a manager circuit 520 which, for example, correspond functionally to PRF 310 and manager circuit 320 (respectively). In an embodiment, PRF 510 comprises multiple entries (such as the illustrative entries 512a, 512b, . . . , 512x shown), respective portions of which are available to be variously allocated. For example, respective sub-portions of entries 512a, 512b, . . . , 512x are variously available each to be allocated—e.g., either individually or in combination with another such sub-portion—to correspond to a respective logical register. In the example embodiment shown, such sub-portions comprise minimum allocable sub-portions 514a, 516a, 514b, 516b, 514x, and 516x. In an embodiment, the entries 512 are identifiable each by a different respective one of indices 518 (such as the illustrative index values INa, INb, . . . , INx shown).

Manager circuit 520 includes, is coupled to access, or otherwise operates based on, a register alias table (RAT) 530 and/or allocation state information 540 which (for example) correspond functionally to RAT 330 and state information 340, respectively. In the example embodiment shown, RAT 530 include entries (such as the illustrative entries 532a, 532b, . . . , 532y shown) which each correspond to a different respective logical register. Entries 532a, 532b, . . . , 532y comprise respective first fields 534a, 534b, . . . , 534y which are each to store an identifier of the corresponding logical register. Entries 532a, 532b, . . . , 532y further comprise respective second fields 536a, 536b, . . . , 536y which are each to store an identifier of a respective PRF entry portion (if any) which is currently allocated to a corresponding logical register.

State information 540 is provided with a table, bitmap, or other suitable data structure, which, for example, is comprises entries (or sets of bits)—such as the illustrative entries 542a, 542b, . . . , 542x shown—that each correspond to a different respective one of entries 512a, 512b, . . . , 512x. For a given one of entries 542a, 542b, . . . , 542x, the entry 542 comprises two or more fields which each correspond to a different respective minimum allocable sub-portion of the corresponding PRF entry. By way of illustration and not limitation, fields 544a, 546a, 544b, 546b, 544x, and 546x variously provide functionality such as that of fields 344a, 346a, 344b, 346b, 344x, and 346x (respectively).

In an illustrative scenario according to one embodiment, an access unit 526 of manager circuit 520 receives a signal 502 which includes an identifier of a logical register. Signal 502 implicitly or explicitly requests to access information at the logical register. By way of illustration and not limitation, the signal 502 comprises the second request which is received at 222 in method 200. In some embodiments, manager circuit 520 further comprises an allocation unit 524 and/or a rename unit 522 which, for example, provide functionality of allocation unit 324 and rename unit 322 (respectively).

Based on signal 502, access unit 526 performs a search of RAT 530 (the search indicated by the label “1”) to determine whether the logical register which is identified by signal 502 is currently allocated to correspond to any entry portion of PRF 510. Where the search of RAT 530 results in a hit, access unit 526 performs a read, write or other suitable access of the PRF entry portion which, as indicated by RAT 530, currently corresponds to the identified logical register.

In an illustrative scenario according to one embodiment, the logical register which is identified by signal 502 is of a register type which corresponds to a capacity that is equal to that of only one minimum allocable sub-portions of PRF 510. In one such scenario, access unit 526 accesses first minimum sub-portion 514b (for example) based on the search of RAT 530. Although some embodiments are not limited in this regard, allocation unit 524—or other suitable logic of manager circuit 520—provides a signal 504 to specify or otherwise indicate to one or more other resources (not shown) that functionality of the identified logical register is now supported by first minimum sub-portion 514b.

In an alternative scenario, the logical register which is identified by signal 502 is of a register type which corresponds to a capacity that is equal to that of an entire entry of PRF 510. In one such scenario, access unit 526 accesses two or more minimum sub-portions—in the example shown, comprising minimum sub-portions 514x, 516x—based on the search of RAT 530.

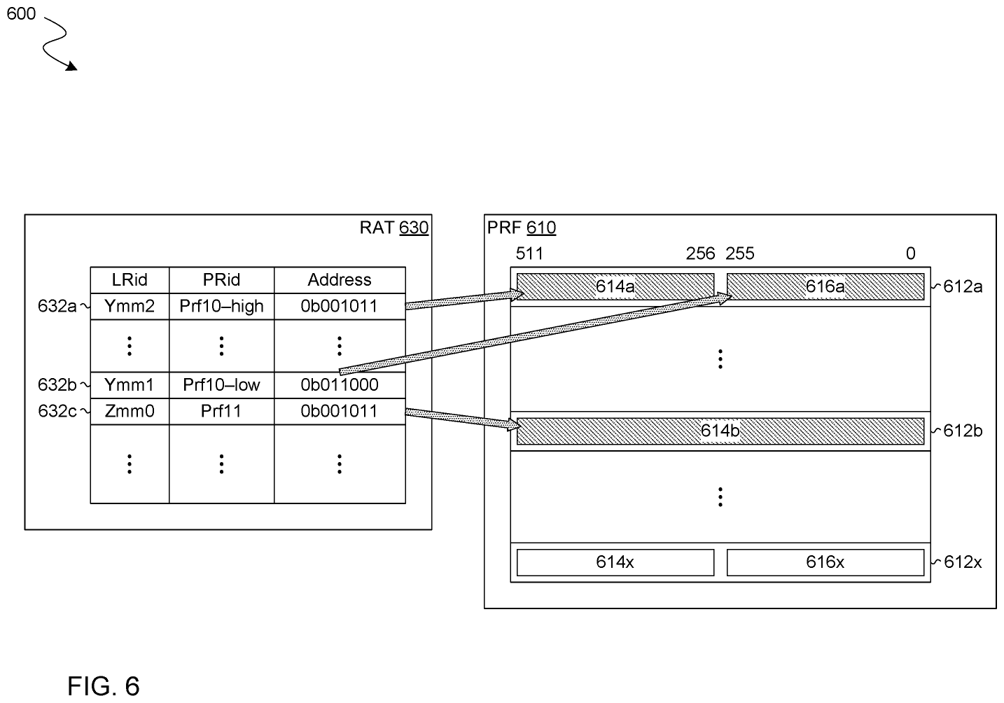

FIG. 6 shows a format of information provided at a device 600 which variously maps logical registers each to a different respective physical register portion according to an embodiment. In an embodiment, device 600 provides functionality of system 100 or of one of devices 300, 400, 500—e.g., wherein operations of method 200 are performed with device 600.

As shown in FIG. 6, device 600 comprises a PRF 610, and a RAT 630 which, for example, provide functionality of PRF 310 and RAT 330 (respectively). In an embodiment, PRF 610 comprises multiple entries (such as the illustrative entries 612a, 612b, 612x shown), respective portions of which are capable of being variously allocated each to correspond to a respective logical register. In the example embodiment shown, the multiple entries 612 of PRF 610 are each 512-bit registers—e.g., wherein minimum allocable sub-portions 614a, 616a of entry 612a each have a 256-bit capacity.

At a given time during operation of device 600, entry portions of PRF 610 are variously allocated each to correspond to a different respective one of multiple logical registers. For example, two or more such logical registers correspond to different respective register types, which have different information capacities.

In an illustrative scenario according to one embodiment, entry 612a at one point comprises at least two different allocated portions—e.g., two minimum allocable sub-portions 614a, 616a—which each correspond to a different respective logical register of a relatively small register type. Concurrently, entry 612b is a uniquely allocated entry—e.g., wherein all minimum allocable sub-portions of entry 612b are allocated, in combination with each other, as a portion 614b which is to correspond to another logical register of a relatively large register type. At the same time, for example, minimum allocable sub-portions 614x, 616x of entry 612x are each an available entry sub-portion.

RAT 630 provides mapping information which enables a fine level of granularity (and, for example, different levels of granularity) for the allocation of entry portions to respective logical registers. In the example embodiment shown, RAT 630 comprises entries (such as the illustrative entries 632a, 632b, 632c shown) which each correspond to a different respective logical register. For example, the number of such entries of RAT 630 is equal to the maximum number of logical registers allowed in device 600. Thus, the entries 632 of RAT 630 are indexed, for example, with identifiers of possible logical registers.

A given entry 632 of RAT 630—e.g., a given one of entries 632a, 632b, 632c—comprises information which describes an allocation (if any) of the corresponding logical register to a particular entry portion of PRF 610. By way of illustration and not limitation, a given entry 632 comprises a respective field (LRid) to store index information (such as a register label, a virtual address or other suitable index) which identifies the logical register to which the given entry 632 corresponds. Furthermore, the given entry 632 comprises another respective field (Address) to store physical address information which specifies a particular PRF entry 612, a portion of which is currently allocated to the logical register which corresponds to the given entry 632. Further still, the given entry 632 comprises another respective field (PRid) which specifies or otherwise indicates a location and/or capacity of that portion of the PRF entry which is currently allocated to the given entry 632. Although some embodiments are not limited in this regard, mapping information additionally or alternatively allocates PRF resources based on an identifier of an execution thread—e.g., wherein a given PRF entry portion is mapped to correspond to a particular logical register as used by in one thread (but not necessarily as used in another thread).

In an illustrative scenario according to one embodiment, entry 632a identifies a logical register Ymm2 (which is of a 256-bit ymm register type) as corresponding to only an upper sub-portion of entry 612a. Furthermore, entry 632b identifies another logical register Ymm1 (which is also of the 256-bit ymm register type) as corresponding to only a lower sub-portion of entry 612a. Further still, entry 632c identifies a logical register Zmm0 (which is of a 512-bit zmm register type) as corresponding to a combination of all minimum allocable sub-portions of entry 612b. Some embodiments additionally or alternatively provide for the selective allocation of any of various other sub-portions of a PRF entry—e.g., wherein a PRF entry which accommodates allocation to a ymm logical register (or, for example, to a zmm register) comprises sub-portions which are available to be allocated to respective xmm logical registers.

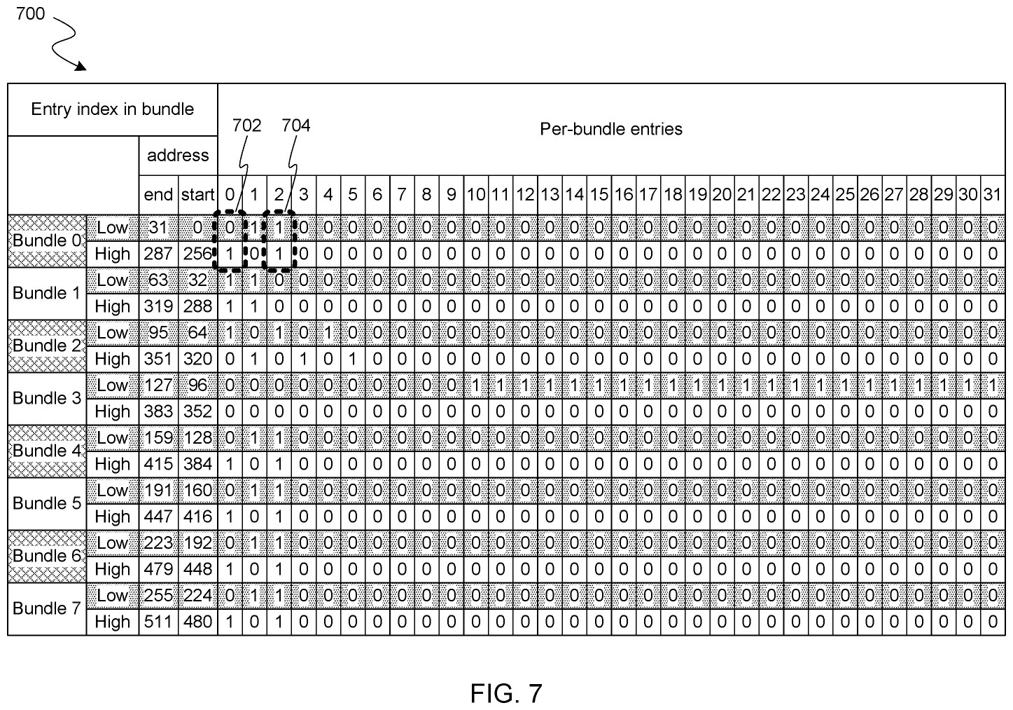

FIG. 7 shows a format of a bitmap 700 which identifies physical register portions as being variously allocated each to a respective logical register according to an embodiment. Bitmap 700 demonstrates one example of an embodiment which facilitates a search to identify an availability of an entry portion which is currently available to be allocated. In an embodiment, bitmap 700 is provided with system 100 or one of devices 300, 400, 500, 600—e.g., wherein operations of method 200 are based on (for example, include), or result in, an accessing of such information.

As shown in FIG. 7, bitmap 700 comprises bits which each correspond to a different respective minimum allocable sub-portion of a PRF that comprises 256 entries. In the example embodiment shown, each of the 256 entries is a 512-bit physical register, and each minimum allocable sub-portion has a 256-bit capacity. Accordingly, each PRF entry comprises a respective two minimum sub-portion which are allocable either individually, or in combination with each other.

In one such embodiment, a relatively low granularity addressing—e.g., at the level of an individual PRF entry—is provided with 8 address bits that enables the identification of any of the 256 (or 2⁸) entries of the PRF. Moreover, a relatively high granularity addressing—e.g., at the level of one minimum allocable sub-portion—is further provided with an additional (ninth) address bit that enables the identification of any of the 512 (or 2⁹) minimum sub-portions of the PRF. For example, a lower minimum allocable sub-portion of a PRF entry is indicated by the ninth bit being equal to zero (0), wherein the upper minimum allocable sub-portion of that same PRF entry is indicated by the ninth bit being equal to one (1). In the example embodiment shown, this ninth address bit is a most significant bit in an addressing scheme which us used to access bitmap 700.

Although some embodiments are not limited in this regard, such an addressing scheme enables configuration of the PRF to provide a first (“Low”) logical file which comprises the respective lower minimum allocable sub-portions of the PRF entries. In one such embodiment, the configuration is for the PRF to further provide a second (“High”) logical file which comprises the respective upper minimum allocable sub-portions of the PRF entries.

For each bit of bitmap 700, a respective value of the bit specifies whether (or not) the corresponding minimum allocable entry sub-portion is currently allocated to a given logical register. By way of illustration and not limitation, bits 702 specify that an upper minimum allocable sub-portion of a first PRF entry is currently allocated, and that a lower minimum allocable sub-portion of that same first PRF entry is available (and not currently allocated). By contrast, bits 704 specify that both of the minimum allocable sub-portions of a second PRF entry are currently allocated (although it is not specified in bitmap 700 whether or not these sub-portions are allocated to the same logical register).

In some embodiments, the PRF entries represented in bitmap 700 are variously arranged in multiple bundles which, for example, are variously accessible each with a different respective read port and/or each with a different respective write port. In the example embodiment shown, the 256 PRF entries are divided into eight such bundles. However, any of various other types of bundling of PRF entries is provided, in different embodiments.

### Exemplary Computer Architectures

Detailed below are describes of exemplary computer architectures. Other system designs and configurations known in the arts for laptop, desktop, and handheld personal computers (PC)s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are generally suitable.

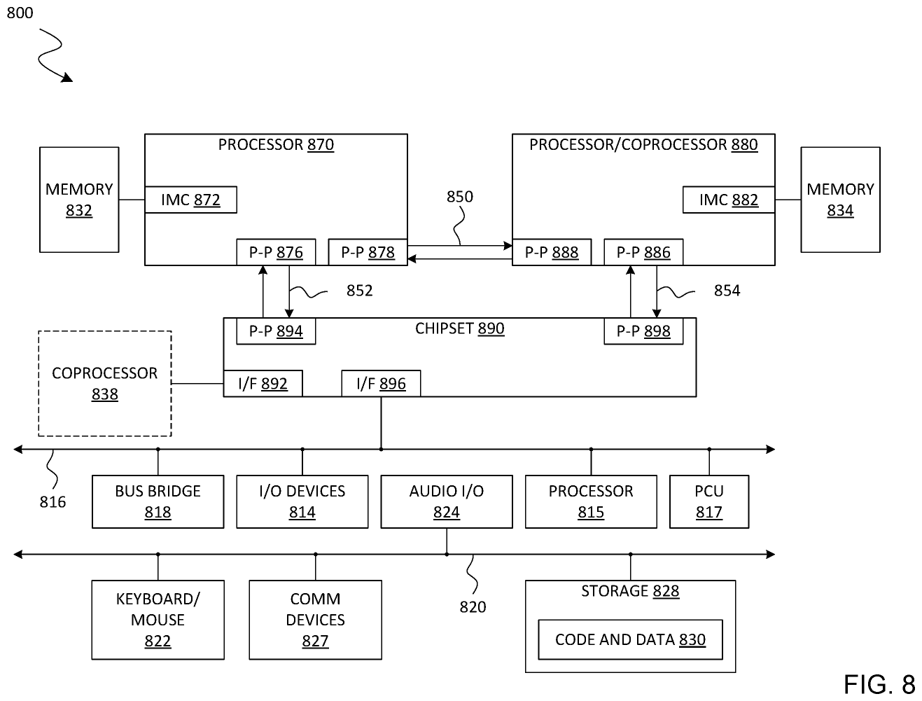

FIG. 8 illustrates an exemplary system. Multiprocessor system 800 is a point-to-point interconnect system and includes a plurality of processors including a first processor 870 and a second processor 880 coupled via a point-to-point interconnect 850. In some examples, the first processor 870 and the second processor 880 are homogeneous. In some examples, first processor 870 and the second processor 880 are heterogenous. Though the exemplary system 800 is shown to have two processors, the system may have three or more processors, or may be a single processor system.

Processors 870 and 880 are shown including integrated memory controller (IMC) circuitry 872 and 882, respectively. Processor 870 also includes as part of its interconnect controller point-to-point (P-P) interfaces 876 and 878; similarly, second processor 880 includes P-P interfaces 886 and 888. Processors 870, 880 may exchange information via the point-to-point (P-P) interconnect 850 using P-P interface circuits 878, 888. IMCs 872 and 882 couple the processors 870, 880 to respective memories, namely a memory 832 and a memory 834, which may be portions of main memory locally attached to the respective processors.

Processors 870, 880 may each exchange information with a chipset 890 via individual P-P interconnects 852, 854 using point to point interface circuits 876, 894, 886, 898. Chipset 890 may optionally exchange information with a coprocessor 838 via an interface 892. In some examples, the coprocessor 838 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 870, 880 or outside of both processors, yet connected with the processors via P-P interconnect, such that either or both processors' local cache information may be stored in the shared cache if a processor is placed into a low power mode.

Chipset 890 may be coupled to a first interconnect 816 via an interface 896. In some examples, first interconnect 816 may be a Peripheral Component Interconnect (PCI) interconnect, or an interconnect such as a PCI Express interconnect or another I/O interconnect. In some examples, one of the interconnects couples to a power control unit (PCU) 817, which may include circuitry, software, and/or firmware to perform power management operations with regard to the processors 870, 880 and/or co-processor 838. PCU 817 provides control information to a voltage regulator (not shown) to cause the voltage regulator to generate the appropriate regulated voltage. PCU 817 also provides control information to control the operating voltage generated. In various examples, PCU 817 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 817 is illustrated as being present as logic separate from the processor 870 and/or processor 880. In other cases, PCU 817 may execute on a given one or more of cores (not shown) of processor 870 or 880. In some cases, PCU 817 may be implemented as a microcontroller (dedicated or general-purpose) or other control logic configured to execute its own dedicated power management code, sometimes referred to as P-code. In yet other examples, power management operations to be performed by PCU 817 may be implemented externally to a processor, such as by way of a separate power management integrated circuit (PMIC) or another component external to the processor. In yet other examples, power management operations to be performed by PCU 817 may be implemented within BIOS or other system software.

Various I/O devices 814 may be coupled to first interconnect 816, along with a bus bridge 818 which couples first interconnect 816 to a second interconnect 820. In some examples, one or more additional processor(s) 815, such as coprocessors, high-throughput many integrated core (MIC) processors, GPGPUs, accelerators (such as graphics accelerators or digital signal processing (DSP) units), field programmable gate arrays (FPGAs), or any other processor, are coupled to first interconnect 816. In some examples, second interconnect 820 may be a low pin count (LPC) interconnect. Various devices may be coupled to second interconnect 820 including, for example, a keyboard and/or mouse 822, communication devices 827 and a storage circuitry 828. Storage circuitry 828 may be one or more non-transitory machine-readable storage media as described below, such as a disk drive or other mass storage device which may include instructions/code and data 830 in some examples. Further, an audio I/O 824 may be coupled to second interconnect 820. Note that other architectures than the point-to-point architecture described above are possible. For example, instead of the point-to-point architecture, a system such as multiprocessor system 800 may implement a multi-drop interconnect or other such architecture.

### Exemplary Core Architectures, Processors, and Computer Architectures.

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may include on the same die as the described CPU (sometimes referred to as the application core(s) or application processor(s)), the above described coprocessor, and additional functionality. Exemplary core architectures are described next, followed by descriptions of exemplary processors and computer architectures.

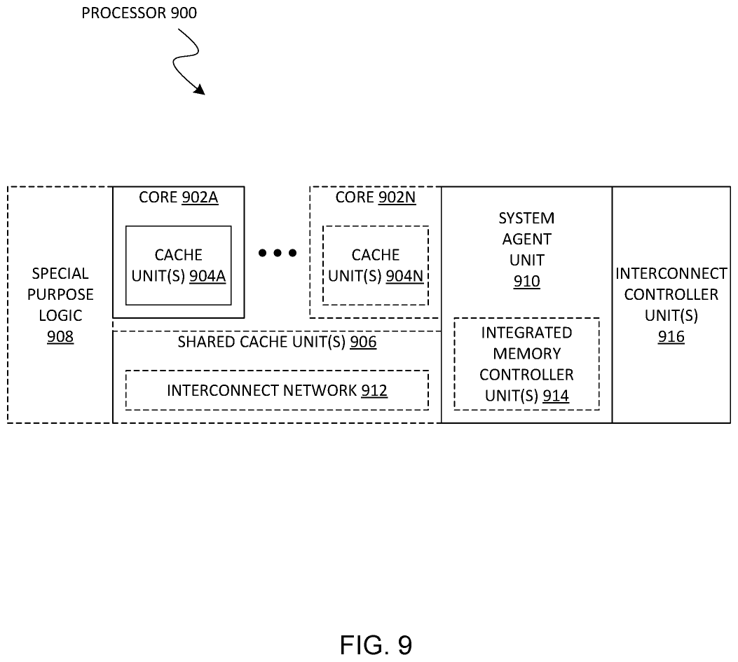

FIG. 9 illustrates a block diagram of an example processor 900 that may have more than one core and an integrated memory controller. The solid lined boxes illustrate a processor 900 with a single core 902A, a system agent unit circuitry 910, a set of one or more interconnect controller unit(s) circuitry 916, while the optional addition of the dashed lined boxes illustrates an alternative processor 900 with multiple cores 902A-N, a set of one or more integrated memory controller unit(s) circuitry 914 in the system agent unit circuitry 910, and special purpose logic 908, as well as a set of one or more interconnect controller units circuitry 916. Note that the processor 900 may be one of the processors 870 or 880, or co-processor 838 or 815 of FIG. 8.

Thus, different implementations of the processor 900 may include: 1) a CPU with the special purpose logic 908 being integrated graphics and/or scientific (throughput) logic (which may include one or more cores, not shown), and the cores 902A-N being one or more general purpose cores (e.g., general purpose in-order cores, general purpose out-of-order cores, or a combination of the two); 2) a coprocessor with the cores 902A-N being a large number of special purpose cores intended primarily for graphics and/or scientific (throughput); and 3) a coprocessor with the cores 902A-N being a large number of general purpose in-order cores. Thus, the processor 900 may be a general-purpose processor, coprocessor or special-purpose processor, such as, for example, a network or communication processor, compression engine, graphics processor, GPGPU (general purpose graphics processing unit circuitry), a high-throughput many integrated core (MIC) coprocessor (including 30 or more cores), embedded processor, or the like. The processor may be implemented on one or more chips. The processor 900 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 904A-N within the cores 902A-N, a set of one or more shared cache unit(s) circuitry 906, and external memory (not shown) coupled to the set of integrated memory controller unit(s) circuitry 914. The set of one or more shared cache unit(s) circuitry 906 may include one or more mid-level caches, such as level 2 (L2), level 3 (L3), level 4 (L4), or other levels of cache, such as a last level cache (LLC), and/or combinations thereof. While in some examples ring-based interconnect network circuitry 912 interconnects the special purpose logic 908 (e.g., integrated graphics logic), the set of shared cache unit(s) circuitry 906, and the system agent unit circuitry 910, alternative examples use any number of well-known techniques for interconnecting such units. In some examples, coherency is maintained between one or more of the shared cache unit(s) circuitry 906 and cores 902A-N.

In some examples, one or more of the cores 902A-N are capable of multi-threading. The system agent unit circuitry 910 includes those components coordinating and operating cores 902A-N. The system agent unit circuitry 910 may include, for example, power control unit (PCU) circuitry and/or display unit circuitry (not shown). The PCU may be or may include logic and components needed for regulating the power state of the cores 902A-N and/or the special purpose logic 908 (e.g., integrated graphics logic). The display unit circuitry is for driving one or more externally connected displays.

The cores 902A-N may be homogenous in terms of instruction set architecture (ISA). Alternatively, the cores 902A-N may be heterogeneous in terms of ISA; that is, a subset of the cores 902A-N may be capable of executing an ISA, while other cores may be capable of executing only a subset of that ISA or another ISA.

### Exemplary Core Architectures—In-Order and Out-of-Order Core Block Diagram.

FIG. 10A is a block diagram illustrating both an exemplary in-order pipeline and an exemplary register renaming, out-of-order issue/execution pipeline according to examples. FIG. 10B is a block diagram illustrating both an exemplary example of an in-order architecture core and an exemplary register renaming, out-of-order issue/execution architecture core to be included in a processor according to examples. The solid lined boxes in FIGS. 10A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 10A, a processor pipeline 1000 includes a fetch stage 1002, an optional length decoding stage 1004, a decode stage 1006, an optional allocation (Alloc) stage 1008, an optional renaming stage 1010, a schedule (also known as a dispatch or issue) stage 1012, an optional register read/memory read stage 1014, an execute stage 1016, a write back/memory write stage 1018, an optional exception handling stage 1022, and an optional commit stage 1024. One or more operations can be performed in each of these processor pipeline stages. For example, during the fetch stage 1002, one or more instructions are fetched from instruction memory, and during the decode stage 1006, the one or more fetched instructions may be decoded, addresses (e.g., load store unit (LSU) addresses) using forwarded register ports may be generated, and branch forwarding (e.g., immediate offset or a link register (LR)) may be performed. In one example, the decode stage 1006 and the register read/memory read stage 1014 may be combined into one pipeline stage. In one example, during the execute stage 1016, the decoded instructions may be executed, LSU address/data pipelining to an Advanced Microcontroller Bus (AMB) interface may be performed, multiply and add operations may be performed, arithmetic operations with branch results may be performed, etc.

By way of example, the exemplary register renaming, out-of-order issue/execution architecture core of FIG. 10B may implement the pipeline 1000 as follows: 1) the instruction fetch circuitry 1038 performs the fetch and length decoding stages 1002 and 1004; 2) the decode circuitry 1040 performs the decode stage 1006; 3) the rename/allocator unit circuitry 1052 performs the allocation stage 1008 and renaming stage 1010; 4) the scheduler(s) circuitry 1056 performs the schedule stage 1012; 5) the physical register file(s) circuitry 1058 and the memory unit circuitry 1070 perform the register read/memory read stage 1014; the execution cluster(s) 1060 perform the execute stage 1016; 6) the memory unit circuitry 1070 and the physical register file(s) circuitry 1058 perform the write back/memory write stage 1018; 7) various circuitry may be involved in the exception handling stage 1022; and 8) the retirement unit circuitry 1054 and the physical register file(s) circuitry 1058 perform the commit stage 1024.

FIG. 10B shows a processor core 1090 including front-end unit circuitry 1030 coupled to an execution engine unit circuitry 1050, and both are coupled to a memory unit circuitry 1070. The core 1090 may be a reduced instruction set architecture computing (RISC) core, a complex instruction set architecture computing (CISC) core, a very long instruction word (VLIW) core, or a hybrid or alternative core type. As yet another option, the core 1090 may be a special-purpose core, such as, for example, a network or communication core, compression engine, coprocessor core, general purpose computing graphics processing unit (GPGPU) core, graphics core, or the like.

The front end unit circuitry 1030 may include branch prediction circuitry 1032 coupled to an instruction cache circuitry 1034, which is coupled to an instruction translation lookaside buffer (TLB) 1036, which is coupled to instruction fetch circuitry 1038, which is coupled to decode circuitry 1040. In one example, the instruction cache circuitry 1034 is included in the memory unit circuitry 1070 rather than the front-end circuitry 1030. The decode circuitry 1040 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 1040 may further include an address generation unit (AGU, not shown) circuitry. In one example, the AGU generates an LSU address using forwarded register ports, and may further perform branch forwarding (e.g., immediate offset branch forwarding, LR register branch forwarding, etc.). The decode circuitry 1040 may be implemented using various different mechanisms. Examples of suitable mechanisms include, but are not limited to, look-up tables, hardware implementations, programmable logic arrays (PLAs), microcode read only memories (ROMs), etc. In one example, the core 1090 includes a microcode ROM (not shown) or other medium that stores microcode for certain macroinstructions (e.g., in decode circuitry 1040 or otherwise within the front end circuitry 1030). In one example, the decode circuitry 1040 includes a micro-operation (micro-op) or operation cache (not shown) to hold/cache decoded operations, micro-tags, or micro-operations generated during the decode or other stages of the processor pipeline 1000. The decode circuitry 1040 may be coupled to rename/allocator unit circuitry 1052 in the execution engine circuitry 1050.

The execution engine circuitry 1050 includes the rename/allocator unit circuitry 1052 coupled to a retirement unit circuitry 1054 and a set of one or more scheduler(s) circuitry 1056. The scheduler(s) circuitry 1056 represents any number of different schedulers, including reservations stations, central instruction window, etc. In some examples, the scheduler(s) circuitry 1056 can include arithmetic logic unit (ALU) scheduler/scheduling circuitry, ALU queues, arithmetic generation unit (AGU) scheduler/scheduling circuitry, AGU queues, etc. The scheduler(s) circuitry 1056 is coupled to the physical register file(s) circuitry 1058. Each of the physical register file(s) circuitry 1058 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one example, the physical register file(s) circuitry 1058 includes vector registers unit circuitry, writemask registers unit circuitry, and scalar register unit circuitry. These register units may provide architectural vector registers, vector mask registers, general-purpose registers, etc. The physical register file(s) circuitry 1058 is coupled to the retirement unit circuitry 1054 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 1054 and the physical register file(s) circuitry 1058 are coupled to the execution cluster(s) 1060. The execution cluster(s) 1060 includes a set of one or more execution unit(s) circuitry 1062 and a set of one or more memory access circuitry 1064. The execution unit(s) circuitry 1062 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). While some examples may include a number of execution units or execution unit circuitry dedicated to specific functions or sets of functions, other examples may include only one execution unit circuitry or multiple execution units/execution unit circuitry that all perform all functions. The scheduler(s) circuitry 1056, physical register file(s) circuitry 1058, and execution cluster(s) 1060 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster—and in the case of a separate memory access pipeline, certain examples are implemented in which only the execution cluster of this pipeline has the memory access unit(s) circuitry 1064). It should also be understood that where separate pipelines are used, one or more of these pipelines may be out-of-order issue/execution and the rest in-order.

In some examples, the execution engine unit circuitry 1050 may perform load store unit (LSU) address/data pipelining to an Advanced Microcontroller Bus (AMB) interface (not shown), and address phase and writeback, data phase load, store, and branches.

The set of memory access circuitry 1064 is coupled to the memory unit circuitry 1070, which includes data TLB circuitry 1072 coupled to a data cache circuitry 1074 coupled to a level 2 (L2) cache circuitry 1076. In one exemplary example, the memory access circuitry 1064 may include a load unit circuitry, a store address unit circuit, and a store data unit circuitry, each of which is coupled to the data TLB circuitry 1072 in the memory unit circuitry 1070. The instruction cache circuitry 1034 is further coupled to the level 2 (L2) cache circuitry 1076 in the memory unit circuitry 1070. In one example, the instruction cache 1034 and the data cache 1074 are combined into a single instruction and data cache (not shown) in L2 cache circuitry 1076, a level 3 (L3) cache circuitry (not shown), and/or main memory. The L2 cache circuitry 1076 is coupled to one or more other levels of cache and eventually to a main memory.

The core 1090 may support one or more instructions sets (e.g., the x86 instruction set architecture (optionally with some extensions that have been added with newer versions); the MIPS instruction set architecture; the ARM instruction set architecture (optionally with optional additional extensions such as NEON)), including the instruction(s) described herein. In one example, the core 1090 includes logic to support a packed data instruction set architecture extension (e.g., AVX1, AVX2), thereby allowing the operations used by many multimedia applications to be performed using packed data.

### Exemplary Execution Unit(s) Circuitry.

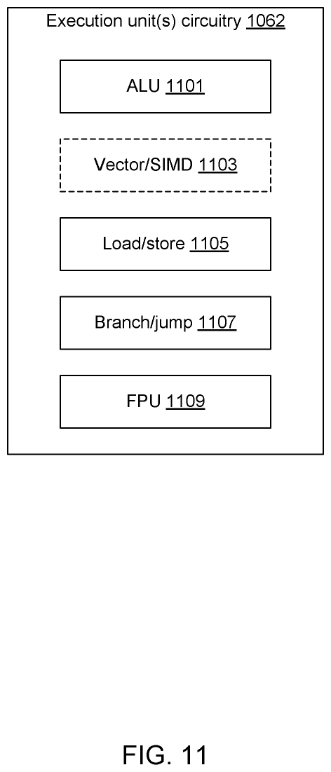

FIG. 11 illustrates examples of execution unit(s) circuitry, such as execution unit(s) circuitry 1062 of FIG. 10B. As illustrated, execution unit(s) circuitry 1062 may include one or more ALU circuits 1101, optional vector/single instruction multiple data (SIMD) circuits 1103, load/store circuits 1105, branch/jump circuits 1107, and/or Floating-point unit (FPU) circuits 1109. ALU circuits 1101 perform integer arithmetic and/or Boolean operations. Vector/SIMD circuits 1103 perform vector/SIMD operations on packed data (such as SIMD/vector registers). Load/store circuits 1105 execute load and store instructions to load data from memory into registers or store from registers to memory. Load/store circuits 1105 may also generate addresses. Branch/jump circuits 1107 cause a branch or jump to a memory address depending on the instruction. FPU circuits 1109 perform floating-point arithmetic. The width of the execution unit(s) circuitry 1062 varies depending upon the example and can range from 16-bit to 1,024-bit, for example. In some examples, two or more smaller execution units are logically combined to form a larger execution unit (e.g., two 128-bit execution units are logically combined to form a 256-bit execution unit).

### Exemplary Register Architecture

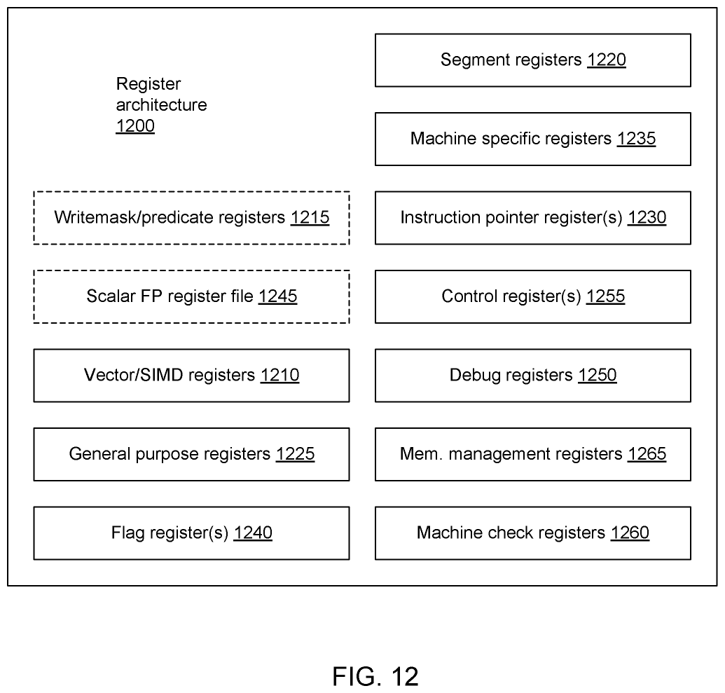

FIG. 12 is a block diagram of a register architecture 1200 according to some examples. As illustrated, the register architecture 1200 includes vector/SIMD registers 1210 that vary from 128-bit to 1,024 bits width. In some examples, the vector/SIMD registers 1210 are physically 512-bits and, depending upon the mapping, only some of the lower bits are used. For example, in some examples, the vector/SIMD registers 1210 are ZMM registers which are 512 bits: the lower 256 bits are used for YMM registers and the lower 128 bits are used for XMM registers. As such, there is an overlay of registers. In some examples, a vector length field selects between a maximum length and one or more other shorter lengths, where each such shorter length is half the length of the preceding length. Scalar operations are operations performed on the lowest order data element position in a ZMM/YMM/XMM register; the higher order data element positions are either left the same as they were prior to the instruction or zeroed depending on the example.

In some examples, the register architecture 1200 includes writemask/predicate registers 1215. For example, in some examples, there are 8 writemask/predicate registers (sometimes called k0 through k7) that are each 16-bit, 32-bit, 64-bit, or 128-bit in size. Writemask/predicate registers 1215 may allow for merging (e.g., allowing any set of elements in the destination to be protected from updates during the execution of any operation) and/or zeroing (e.g., zeroing vector masks allow any set of elements in the destination to be zeroed during the execution of any operation). In some examples, each data element position in a given writemask/predicate register 1215 corresponds to a data element position of the destination. In other examples, the writemask/predicate registers 1215 are scalable and consists of a set number of enable bits for a given vector element (e.g., 8 enable bits per 64-bit vector element).

The register architecture 1200 includes a plurality of general-purpose registers 1225. These registers may be 16-bit, 32-bit, 64-bit, etc. and can be used for scalar operations. In some examples, these registers are referenced by the names RAX, RBX, RCX, RDX, RBP, RSI, RDI, RSP, and R8 through R15.

In some examples, the register architecture 1200 includes scalar floating-point (FP) register 1245 which is used for scalar floating-point operations on 32/64/80-bit floating-point data using the x87 instruction set architecture extension or as MMX registers to perform operations on 64-bit packed integer data, as well as to hold operands for some operations performed between the MMX and XMM registers.

One or more flag registers 1240 (e.g., EFLAGS, RFLAGS, etc.) store status and control information for arithmetic, compare, and system operations. For example, the one or more flag registers 1240 may store condition code information such as carry, parity, auxiliary carry, zero, sign, and overflow. In some examples, the one or more flag registers 1240 are called program status and control registers.

Segment registers 1220 contain segment points for use in accessing memory. In some examples, these registers are referenced by the names CS, DS, SS, ES, FS, and GS.

Machine specific registers (MSRs) 1235 control and report on processor performance. Most MSRs 1235 handle system-related functions and are not accessible to an application program. Machine check registers 1260 consist of control, status, and error reporting MSRs that are used to detect and report on hardware errors.

One or more instruction pointer register(s) 1230 store an instruction pointer value. Control register(s) 1255 (e.g., CR0-CR4) determine the operating mode of a processor (e.g., processor 870, 880, 838, 815, and/or 900) and the characteristics of a currently executing task. Debug registers 1250 control and allow for the monitoring of a processor or core's debugging operations.

Memory (mem) management registers 1265 specify the locations of data structures used in protected mode memory management. These registers may include a GDTR, IDRT, task register, and a LDTR register.

Alternative examples may use wider or narrower registers. Additionally, alternative examples may use more, less, or different register files and registers. The register architecture 1200 may, for example, be used in physical register file(s) circuitry 1058.

The description herein includes numerous details to provide a more thorough explanation of the embodiments of the present disclosure. It will be apparent to one skilled in the art, however, that embodiments of the present disclosure may be practiced without these specific details. In other instances, well-known structures and devices are shown in block diagram form, rather than in detail, in order to avoid obscuring embodiments of the present disclosure.

Note that in the corresponding drawings of the embodiments, signals are represented with lines. Some lines may be thicker, to indicate a greater number of constituent signal paths, and/or have arrows at one or more ends, to indicate a direction of information flow. Such indications are not intended to be limiting. Rather, the lines are used in connection with one or more exemplary embodiments to facilitate easier understanding of a circuit or a logical unit. Any represented signal, as dictated by design needs or preferences, may actually comprise one or more signals that may travel in either direction and may be implemented with any suitable type of signal scheme.

Throughout the specification, and in the claims, the term “connected” means a direct connection, such as electrical, mechanical, or magnetic connection between the things that are connected, without any intermediary devices. The term “coupled” means a direct or indirect connection, such as a direct electrical, mechanical, or magnetic connection between the things that are connected or an indirect connection, through one or more passive or active intermediary devices. The term “circuit” or “module” may refer to one or more passive and/or active components that are arranged to cooperate with one another to provide a desired function. The term “signal” may refer to at least one current signal, voltage signal, magnetic signal, or data/clock signal. The meaning of “a,” “an,” and “the” include plural references. The meaning of “in” includes “in” and “on.”

The term “device” may generally refer to an apparatus according to the context of the usage of that term. For example, a device may refer to a stack of layers or structures, a single structure or layer, a connection of various structures having active and/or passive elements, etc. Generally, a device is a three-dimensional structure with a plane along the x-y direction and a height along the z direction of an x-y-z Cartesian coordinate system. The plane of the device may also be the plane of an apparatus which comprises the device.

The term “scaling” generally refers to converting a design (schematic and layout) from one process technology to another process technology and subsequently being reduced in layout area. The term “scaling” generally also refers to downsizing layout and devices within the same technology node. The term “scaling” may also refer to adjusting (e.g., slowing down or speeding up—i.e. scaling down, or scaling up respectively) of a signal frequency relative to another parameter, for example, power supply level.

The terms “substantially,” “close,” “approximately,” “near,” and “about,” generally refer to being within +/−10% of a target value. For example, unless otherwise specified in the explicit context of their use, the terms “substantially equal,” “about equal” and “approximately equal” mean that there is no more than incidental variation between among things so described. In the art, such variation is typically no more than +/−10% of a predetermined target value.

It is to be understood that the terms so used are interchangeable under appropriate circumstances such that the embodiments of the invention described herein are, for example, capable of operation in other orientations than those illustrated or otherwise described herein.

Unless otherwise specified the use of the ordinal adjectives “first,” “second,” and “third,” etc., to describe a common object, merely indicate that different instances of like objects are being referred to and are not intended to imply that the objects so described must be in a given sequence, either temporally, spatially, in ranking or in any other manner.

The terms “left,” “right,” “front,” “back,” “top,” “bottom,” “over,” “under,” and the like in the description and in the claims, if any, are used for descriptive purposes and not necessarily for describing permanent relative positions. For example, the terms “over,” “under,” “front side,” “back side,” “top,” “bottom,” “over,” “under,” and “on” as used herein refer to a relative position of one component, structure, or material with respect to other referenced components, structures or materials within a device, where such physical relationships are noteworthy. These terms are employed herein for descriptive purposes only and predominantly within the context of a device z-axis and therefore may be relative to an orientation of a device. Hence, a first material “over” a second material in the context of a figure provided herein may also be “under” the second material if the device is oriented upside-down relative to the context of the figure provided. In the context of materials, one material disposed over or under another may be directly in contact or may have one or more intervening materials. Moreover, one material disposed between two materials may be directly in contact with the two layers or may have one or more intervening layers. In contrast, a first material “on” a second material is in direct contact with that second material. Similar distinctions are to be made in the context of component assemblies.

The term “between” may be employed in the context of the z-axis, x-axis or y-axis of a device. A material that is between two other materials may be in contact with one or both of those materials, or it may be separated from both of the other two materials by one or more intervening materials. A material “between” two other materials may therefore be in contact with either of the other two materials, or it may be coupled to the other two materials through an intervening material. A device that is between two other devices may be directly connected to one or both of those devices, or it may be separated from both of the other two devices by one or more intervening devices.

As used throughout this description, and in the claims, a list of items joined by the term “at least one of” or “one or more of” can mean any combination of the listed terms. For example, the phrase “at least one of A, B or C” can mean A; B; C; A and B; A and C; B and C; or A, B and C. It is pointed out that those elements of a figure having the same reference numbers (or names) as the elements of any other figure can operate or function in any manner similar to that described, but are not limited to such.

In addition, the various elements of combinatorial logic and sequential logic discussed in the present disclosure may pertain both to physical structures (such as AND gates, OR gates, or XOR gates), or to synthesized or otherwise optimized collections of devices implementing the logical structures that are Boolean equivalents of the logic under discussion.

Techniques and architectures for facilitating operations with a physical register file are described herein. In the above description, for purposes of explanation, numerous specific details are set forth in order to provide a thorough understanding of certain embodiments. It will be apparent, however, to one skilled in the art that certain embodiments can be practiced without these specific details. In other instances, structures and devices are shown in block diagram form in order to avoid obscuring the description.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed description herein are presented in terms of algorithms and symbolic representations of operations on data bits within a computer memory. These algorithmic descriptions and representations are the means used by those skilled in the computing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion herein, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Certain embodiments also relate to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs) such as dynamic RAM (DRAM), EPROMs, EEPROMs, magnetic or optical cards, or any type of media suitable for storing electronic instructions, and coupled to a computer system bus.

In one or more first embodiments, a device comprises first circuitry to receive a first request comprising an indication of a first logical register, determine, based on the indication, a first register type of the first logical register, identify a first capacity which corresponds to the first register type, and perform, based on the first capacity, a first selection of a first allocation size from among multiple available allocation sizes, and second circuitry coupled to the first circuitry, the second circuitry to perform a search, based on the first selection, to identify an available portion of a physical register file (PRF), wherein, based on the search, the second circuitry is to allocate a first portion of a first entry of the PRF to correspond to the first logical register.

In one or more second embodiments, further to the first embodiment, the second circuitry to perform the search comprises the second circuitry to search a bitmap comprising bits which each correspond to a different respective minimum entry portion of the PRF, wherein each of the bits is to specify whether the corresponding minimum entry portion is currently allocated.

In one or more third embodiments, further to the second embodiment, the first portion is to comprise one or more minimum allocable sub-portions of the first entry, the device further comprises third circuitry which, for each minimum entry portion of the one or more minimum allocable sub-portions, is to update the corresponding bit of the bitmap to indicate that the minimum entry portion is currently allocated.

In one or more fourth embodiments, further to the first embodiment or the second embodiment, the device further comprises third circuitry to receive a second request comprising address information which identifies the first logical register, wherein the address information comprises an indication of the first capacity, and perform, based on the address information, an identification of both the first capacity and a location of the first portion in the first entry, and fourth circuitry coupled to the third circuitry, the fourth circuitry to access the first portion of the first entry based on the identification of the location and the capacity.

In one or more fifth embodiments, further to the fourth embodiment, the PRF comprises a total of 2^{m} registers, wherein m is a first integer, and the third circuitry to perform the identification of the first capacity comprises the third circuitry to make a first determination that the address information comprises a total of m bits, and based on the first determination, make a second determination that the first capacity is equal to a total capacity of the first entry.

In one or more sixth embodiments, further to the fourth embodiment, the PRF comprises a total of 2^{m} registers, wherein m is a first integer, and the third circuitry to perform the identification of the first capacity comprises the third circuitry to make a first determination that the address information comprises a total of n bits, wherein n is a second integer which is greater than m, and based on the first determination, make a second determination that the first capacity is less than a total capacity of the first entry.

In one or more seventh embodiments, further to the first embodiment or the second embodiment, the first circuitry is further to receive a second request comprising an indication of a second logical register, determine a second register type of the second logical register based on the indication, identify a second capacity which corresponds to the second register type, wherein the second capacity is different than the first capacity, and perform, based on the second capacity, a second selection of a second allocation size from among the multiple available allocation sizes, and the second circuitry is further to perform a search, based on the second selection, to identify an available portion of the PRF, wherein, based on the search, the second circuitry is to allocate a second portion of a second entry of the PRF to correspond to the second logical register.

In one or more eighth embodiments, further to the seventh embodiment, the first portion of the first entry is to correspond to the first logical register while the second portion of the second entry corresponds to the second logical register.

In one or more ninth embodiments, further to the eighth embodiment, the first capacity is to be equal to a total capacity of the first entry, the first portion of the first entry is to corresponds to the first logical register while the second portion of the second entry corresponds to the second logical register, and while a third portion of the second entry corresponds to a third logical register.

In one or more tenth embodiments, a method comprises receiving a first request comprising an indication of a first logical register, based on the indication, determining a first register type of the first logical register, identifying a first capacity which corresponds to the first register type, based on the first capacity, performing a first selection of a first allocation size from among multiple available allocation sizes, performing a search, based on the first selection, to identify an available portion of a physical register file (PRF), based on the search, allocating a first portion of a first entry of the PRF to correspond to the first logical register.

In one or more eleventh embodiments, further to the tenth embodiment, performing the search comprises searching a bitmap comprising bits which each correspond to a different respective minimum entry portion of the PRF, wherein each of the bits is to specify whether the corresponding minimum entry portion is currently allocated.

In one or more twelfth embodiments, further to the eleventh embodiment, the first portion comprises one or more minimum allocable sub-portions of the first entry, the method further comprises for each minimum entry portion of the one or more minimum allocable sub-portions, updating the corresponding bit of the bitmap to indicate that the minimum entry portion is currently allocated.

In one or more thirteenth embodiments, further to the tenth embodiment or the eleventh embodiment, the method further comprises receiving a second request comprising address information which identifies the first logical register, wherein the address information comprises an indication of the first capacity, based on the address information, performing an identification of the first capacity, and a location of the first portion in the first entry, and accessing the first portion of the first entry based on the identification of the location and the capacity.

In one or more fourteenth embodiments, further to the thirteenth embodiment, the PRF comprises a total of 2^{m} registers, wherein m is a first integer, and performing the identification of the first capacity comprises making a first determination that the address information comprises a total of m bits, and based on the first determination, making a second determination that the first capacity is equal to a total capacity of the first entry.

In one or more fifteenth embodiments, further to the thirteenth embodiment, the PRF comprises a total of 2^{m} registers, wherein m is a first integer, and performing the identification of the first capacity comprises making a first determination that the address information comprises a total of n bits, wherein n is a second integer which is greater than m, and based on the first determination, making a second determination that the first capacity is less than a total capacity of the first entry.

In one or more sixteenth embodiments, further to the tenth embodiment or the eleventh embodiment, the method further comprises receiving a second request comprising an indication of a second logical register, based on the indication, determining a second register type of the second logical register, identifying a second capacity which corresponds to the second register type, wherein the second capacity is different than the first capacity, based on the second capacity, performing a second selection of a second allocation size from among the multiple available allocation sizes, performing a search, based on the second selection, to identify an available portion of the PRF, and based on the search, allocating a second portion of a second entry of the PRF to correspond to the second logical register.

In one or more seventeenth embodiments, further to the sixteenth embodiment, the first portion of the first entry corresponds to the first logical register while the second portion of the second entry corresponds to the second logical register.

In one or more eighteenth embodiments, further to the seventeenth embodiment, the first capacity is equal to a total capacity of the first entry, the first portion of the first entry corresponds to the first logical register while the second portion of the second entry corresponds to the second logical register, and while a third portion of the second entry corresponds to a third logical register.

In one or more nineteenth embodiments, a system comprises a processor comprising first circuitry to receive a first request comprising an indication of a first logical register, determine, based on the indication, a first register type of the first logical register, identify a first capacity which corresponds to the first register type, and perform, based on the first capacity, a first selection of a first allocation size from among multiple available allocation sizes, and second circuitry coupled to the first circuitry, the second circuitry to perform a search, based on the first selection, to identify an available portion of a physical register file (PRF), wherein, based on the search, the second circuitry is to allocate a first portion of a first entry of the PRF to correspond to the first logical register, and a network interface coupled to the processor, the network interface to receive and transmit data over a network.

In one or more twentieth embodiments, further to the nineteenth embodiment, the second circuitry to perform the search comprises the second circuitry to search a bitmap comprising bits which each correspond to a different respective minimum entry portion of the PRF, wherein each of the bits is to specify whether the corresponding minimum entry portion is currently allocated.

In one or more twenty-first embodiments, further to the twentieth embodiment, the first portion is to comprise one or more minimum allocable sub-portions of the first entry, the processor further comprises third circuitry which, for each minimum entry portion of the one or more minimum allocable sub-portions, is to update the corresponding bit of the bitmap to indicate that the minimum entry portion is currently allocated.

In one or more twenty-second embodiments, further to the nineteenth embodiment or the twentieth embodiment, the processor further comprises third circuitry to receive a second request comprising address information which identifies the first logical register, wherein the address information comprises an indication of the first capacity, and perform, based on the address information, an identification of both the first capacity and a location of the first portion in the first entry, and fourth circuitry coupled to the third circuitry, the fourth circuitry to access the first portion of the first entry based on the identification of the location and the capacity.

In one or more twenty-third embodiments, further to the twenty-second embodiment, the PRF comprises a total of 2^{m} registers, wherein m is a first integer, and the third circuitry to perform the identification of the first capacity comprises the third circuitry to make a first determination that the address information comprises a total of m bits, and based on the first determination, make a second determination that the first capacity is equal to a total capacity of the first entry.

In one or more twenty-fourth embodiments, further to the twenty-second embodiment, the PRF comprises a total of 2^{m} registers, wherein m is a first integer, and the third circuitry to perform the identification of the first capacity comprises the third circuitry to make a first determination that the address information comprises a total of n bits, wherein n is a second integer which is greater than m, and based on the first determination, make a second determination that the first capacity is less than a total capacity of the first entry.

In one or more twenty-fifth embodiments, further to the nineteenth embodiment or the twentieth embodiment, the first circuitry is further to receive a second request comprising an indication of a second logical register, determine a second register type of the second logical register based on the indication, identify a second capacity which corresponds to the second register type, wherein the second capacity is different than the first capacity, and perform, based on the second capacity, a second selection of a second allocation size from among the multiple available allocation sizes, and the second circuitry is further to perform a search, based on the second selection, to identify an available portion of the PRF, wherein, based on the search, the second circuitry is to allocate a second portion of a second entry of the PRF to correspond to the second logical register.

In one or more twenty-sixth embodiments, further to the twenty-fifth embodiment, the first portion of the first entry is to correspond to the first logical register while the second portion of the second entry corresponds to the second logical register.

In one or more twenty-seventh embodiments, further to the twenty-sixth embodiment, the first capacity is to be equal to a total capacity of the first entry, the first portion of the first entry is to corresponds to the first logical register while the second portion of the second entry corresponds to the second logical register, and while a third portion of the second entry corresponds to a third logical register.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description herein. In addition, certain embodiments are not described with reference to any particular programming language. It will be appreciated that a variety of programming languages may be used to implement the teachings of such embodiments as described herein.

Besides what is described herein, various modifications may be made to the disclosed embodiments and implementations thereof without departing from their scope. Therefore, the illustrations and examples herein should be construed in an illustrative, and not a restrictive sense. The scope of the invention should be measured solely by reference to the claims that follow.

What is claimed is:

1. A device comprising:
first circuitry to:
receive a first request comprising an indication of a first logical register;
determine, based on the indication, a first register type of the first logical register;
identify a first capacity which corresponds to the first register type; and
perform, based on the first capacity, a first selection of a first allocation size from among multiple available allocation sizes; and
second circuitry coupled to the first circuitry, the second circuitry to perform a search, based on the first selection, to identify an available portion of a physical register file (PRF), wherein, based on the search, the second circuitry is to allocate a first portion of a first entry of the PRF to correspond to the first logical register.

2. The device of claim 1, wherein the second circuitry to perform the search comprises the second circuitry to search a bitmap comprising bits which each correspond to a different respective minimum entry portion of the PRF, wherein each of the bits is to specify whether the corresponding minimum entry portion is currently allocated.

3. The device of claim 2, wherein:
the first portion is to comprise one or more minimum allocable sub-portions of the first entry;
the device further comprises:
third circuitry which, for each minimum entry portion of the one or more minimum allocable sub-portions, is to update the corresponding bit of the bitmap to indicate that the minimum entry portion is currently allocated.

4. The device of claim 1, further comprising:
third circuitry to:
receive a second request comprising address information which identifies the first logical register, wherein the address information comprises an indication of the first capacity; and
perform, based on the address information, an identification of both the first capacity and a location of the first portion in the first entry; and
fourth circuitry coupled to the third circuitry, the fourth circuitry to access the first portion of the first entry based on the identification of the location and the capacity.

5. The device of claim 4, wherein:
the PRF comprises a total of 2^{m} registers, wherein m is a first integer; and
the third circuitry to perform the identification of the first capacity comprises the third circuitry to:
make a first determination that the address information comprises a total of m bits; and
based on the first determination, make a second determination that the first capacity is equal to a total capacity of the first entry.

6. The device of claim 4, wherein:
the PRF comprises a total of 2^{m} registers, wherein m is a first integer; and
the third circuitry to perform the identification of the first capacity comprises the third circuitry to:
make a first determination that the address information comprises a total of n bits, wherein n is a second integer which is greater than m; and
based on the first determination, make a second determination that the first capacity is less than a total capacity of the first entry.

7. The device of claim 1, wherein:
the first circuitry is further to:
receive a second request comprising an indication of a second logical register;
determine a second register type of the second logical register based on the indication;
identify a second capacity which corresponds to the second register type, wherein the second capacity is different than the first capacity; and
perform, based on the second capacity, a second selection of a second allocation size from among the multiple available allocation sizes; and
the second circuitry is further to perform a search, based on the second selection, to identify an available portion of the PRF, wherein, based on the search, the second circuitry is to allocate a second portion of a second entry of the PRF to correspond to the second logical register.

8. The device of claim 7, wherein the first portion of the first entry is to correspond to the first logical register while the second portion of the second entry corresponds to the second logical register.

9. The device of claim 8, wherein:
the first capacity is to be equal to a total capacity of the first entry;
the first portion of the first entry is to corresponds to the first logical register while the second portion of the second entry corresponds to the second logical register, and while a third portion of the second entry corresponds to a third logical register.

10. A method comprising:
receiving a first request comprising an indication of a first logical register;
based on the indication, determining a first register type of the first logical register;
identifying a first capacity which corresponds to the first register type;
based on the first capacity, performing a first selection of a first allocation size from among multiple available allocation sizes;
performing a search, based on the first selection, to identify an available portion of a physical register file (PRF);
based on the search, allocating a first portion of a first entry of the PRF to correspond to the first logical register.

11. The method of claim 10, wherein performing the search comprises searching a bitmap comprising bits which each correspond to a different respective minimum entry portion of the PRF, wherein each of the bits is to specify whether the corresponding minimum entry portion is currently allocated.

12. The method of claim 11, wherein:
the first portion comprises one or more minimum allocable sub-portions of the first entry;
the method further comprises:
for each minimum entry portion of the one or more minimum allocable sub-portions, updating the corresponding bit of the bitmap to indicate that the minimum entry portion is currently allocated.

13. The method of claim 10, further comprising:
receiving a second request comprising address information which identifies the first logical register, wherein the address information comprises an indication of the first capacity;
based on the address information, performing an identification of the first capacity, and a location of the first portion in the first entry; and
accessing the first portion of the first entry based on the identification of the location and the capacity.

14. The method of claim 13, wherein:
the PRF comprises a total of 2^{m} registers, wherein m is a first integer; and
performing the identification of the first capacity comprises:
making a first determination that the address information comprises a total of m bits; and
based on the first determination, making a second determination that the first capacity is equal to a total capacity of the first entry.

15. The method of claim 13, wherein:
the PRF comprises a total of 2^{m} registers, wherein m is a first integer; and
performing the identification of the first capacity comprises:
making a first determination that the address information comprises a total of n bits, wherein n is a second integer which is greater than m; and
based on the first determination, making a second determination that the first capacity is less than a total capacity of the first entry.

16. The method of claim 10, further comprising:
receiving a second request comprising an indication of a second logical register;
based on the indication, determining a second register type of the second logical register;
identifying a second capacity which corresponds to the second register type, wherein the second capacity is different than the first capacity;
based on the second capacity, performing a second selection of a second allocation size from among the multiple available allocation sizes;
performing a search, based on the second selection, to identify an available portion of the PRF; and
based on the search, allocating a second portion of a second entry of the PRF to correspond to the second logical register.

17. A system comprising:
a processor comprising:
first circuitry to:
receive a first request comprising an indication of a first logical register;
determine, based on the indication, a first register type of the first logical register;
identify a first capacity which corresponds to the first register type; and
perform, based on the first capacity, a first selection of a first allocation size from among multiple available allocation sizes; and
second circuitry coupled to the first circuitry, the second circuitry to perform a search, based on the first selection, to identify an available portion of a physical register file (PRF), wherein, based on the search, the second circuitry is to allocate a first portion of a first entry of the PRF to correspond to the first logical register; and
a network interface coupled to the processor, the network interface to receive and transmit data over a network.

18. The system of claim 17, wherein the second circuitry to perform the search comprises the second circuitry to search a bitmap comprising bits which each correspond to a different respective minimum entry portion of the PRF, wherein each of the bits is to specify whether the corresponding minimum entry portion is currently allocated.

19. The system of claim 17, further comprising:
third circuitry to:
receive a second request comprising address information which identifies the first logical register, wherein the address information comprises an indication of the first capacity; and
perform, based on the address information, an identification of both the first capacity and a location of the first portion in the first entry; and
fourth circuitry coupled to the third circuitry, the fourth circuitry to access the first portion of the first entry based on the identification of the location and the capacity.

20. The system of claim 17, wherein:
the first circuitry is further to:
receive a second request comprising an indication of a second logical register;
determine a second register type of the second logical register based on the indication;
identify a second capacity which corresponds to the second register type, wherein the second capacity is different than the first capacity; and
perform, based on the second capacity, a second selection of a second allocation size from among the multiple available allocation sizes; and
the second circuitry is further to perform a search, based on the second selection, to identify an available portion of the PRF, wherein, based on the search, the second circuitry is to allocate a second portion of a second entry of the PRF to correspond to the second logical register.
